(19) United States
(12) Patent Application Publication
(10) Pub. No.: US 2011/0050939 A1
(43) Pub. Date: Mar. 3, 2011

(54) Image processing apparatus, image processing method, program, and electronic device

(75) Inventors: Shingo Tsurumi, Saitama (JP); Tomohiko Gotoh, Kanagawa (JP); Yun Sun, Tokyo (JP); Yusuke Sakai, Kanagawa (JP)

(73) Assignee: Sony Corporation, Tokyo (JP)

(21) Appl. No.: 12/806,841

(22) Filed: Aug. 19, 2010

(30) Foreign Application Priority Data
Sep. 2, 2009 (JP) P2009-202266

(51) Int. Cl. H04N 5/228

(52) U.S. Cl. 348/222.1; 348/E05.031

(57) ABSTRACT

An image processing apparatus detects one or more subjects set as detection targets from a shot image acquired by imaging. An image pyramid generator generates an image pyramid used to detect the one or more subjects, wherein the image pyramid is generated by reducing or enlarging the shot image using scales set in advance according to the distance from the imaging unit that conducts the imaging to the one or more subjects to be detected. A detection region determining unit determines, from among the entire image regions in the image pyramid, one or more detection regions for detecting the one or more subjects. A subject detector detects the one or more subjects from the one or more detection regions.

### BACKGROUND OF THE INVENTION

1. Field of the Invention

The present invention relates to an image processing apparatus, an image processing method, a program, and an electronic device. More particularly, the present invention relates to an image processing apparatus, an image processing method, a program, and an electronic device ideal for use when detecting a subject from a shot image, for example.

2. Description of the Related Art

For some time, there have existed detection apparatus that detect faces from a shot image capturing one or more persons' faces, for example (see Japanese Unexamined Patent Application Publication Nos. 2005-157679 and 2005-284487, for example). In such detection apparatus, the shot image is reduced or enlarged at a plurality of scales (i.e., magnification factors), for example. Window images of predetermined size are then cut out from each image in the resulting plurality of scaling images.

Subsequently, the detection apparatus determines whether or not a face is displayed in the cut-out window images. If it is determined that a face is displayed in a particular window image, then the face displayed in that window image is detected as being a face existing in the shot image.

### SUMMARY OF THE INVENTION

Meanwhile, in detection apparatus of the related art, the entire image regions of the scaling images are set as the detection regions to be used for face detection, and the window images are then cut out from these detection regions. For this reason, detecting one or more faces from a shot image involves a large amount of time.

Being devised in light of such circumstances, embodiments of the present invention enable faster detection of features such as human faces from a shot image.

An image processing apparatus in accordance with a first embodiment of the present invention is configured to detect one or more subjects set as detection targets from a shot image acquired by imaging. The image processing apparatus includes: generating means for generating an image pyramid used to detect the one or more subjects, wherein the image pyramid is generated by reducing or enlarging the shot image using scales set in advance according to the distance from the imaging unit that conducts the imaging to the one or more subjects to be detected; determining means for determining, from among the entire image regions in the image pyramid, one or more detection regions for detecting the one or more subjects; and subject detecting means for detecting the one or more subjects from the one or more detection regions. Alternatively, the above image processing apparatus may be realized as a program that causes a computer to function as the image processing apparatus and its included components.

The image processing apparatus may also be provided with estimating means for estimating the orientation of the imaging unit. In this case, the determining means may determine the one or more detection regions on the basis of the estimated orientation of the imaging unit.

The image processing apparatus may also be provided with acquiring means for acquiring detailed information regarding the one or more subjects, on the basis of the subject detection results. In the case where it is estimated that the orientation of the imaging unit is fixed in a particular direction, the determining means may determine the one or more detection regions on the basis of the acquired detailed information.

The detailed information acquired by the acquiring means may at least include position information expressing the positions of the one or more subjects in the shot image. On the basis of such position information, the determining means may determine the one or more detection regions to be the regions in the shot image where the probability of a subject existing therein is equal to or greater than a predetermined threshold value.

The image processing apparatus may also be provided with moving body detecting means for detecting a moving body region representing a moving body in the shot image. In this case, the determining means may determine the one or more detection regions to be the detected moving body region.

The moving body detecting means may set moving body threshold values used to detect the moving body region from among the regions constituting the shot image. Different moving body threshold values may be set for subject vicinity regions that contain the one or more subjects detected by the subject detecting means, and for all regions other than the subject vicinity regions.

In the case where the moving body detecting means detects the moving body region on the basis of whether or not the absolute difference between shot images in adjacent frames is equal to or greater than a moving body threshold value used to detect the moving body region, the moving body detecting means may modify the moving body threshold value according to the difference in imaging times between the shot images.

The image processing apparatus may also be provided with background renewing means for conducting a background renewal process with respect to the regions constituting the shot image. In the case where the moving body detecting means detects the moving body region on the basis of the absolute difference between the shot image, and a background image of only the background wherein the one or more subjects are not captured, the background renewal process may differ for the regions corresponding to the background portions in the shot image, and for the regions corresponding to all portions other than the background in the shot image.

The image processing apparatus may also be provided with outputting means for outputting moving body region information that expresses the moving body region detected by the moving body detecting means, wherein the outputting means outputs the moving body region information before the one or more subjects are detected by the subject detecting means.

The image processing apparatus may also be provided with: distance computing means for computing the distances to imaging targets imaged by the imaging unit; and map generating means for generating a depth map on the basis of the computed distances, wherein the depth map express the distances to respective imaging targets in the shot image. In this case, the determining means may determine the one or more detection regions on the basis of the depth map.

The determining means may subdivide the image pyramid into a plurality of regions according to the scales, and determine the one or more detection regions to be one from among the plurality of regions.

The subject detecting means may detect the one or more subjects in partial regions from among the one or more detection regions. The detection may be made on the basis of whether or not a subject exists in respective partial regions that differ in position by n pixels (where n>1).

The generating means may generate an image pyramid containing a plurality of pyramid images by reducing or enlarging the shot image at respectively different scales. The subject detecting means may detect the one or more subjects from the one or more detection regions for respective pyramid images in the image pyramid, wherein the one or more subjects are detected in order starting from the subject closest to the imaging unit.

The subject detecting means may terminate detection of the one or more subjects in the case where a predetermined number of subjects has been detected.

The subject detecting means may detect the one or more subjects from the one or more detection regions, wherein regions containing already-detected subjects have been removed from the one or more detection regions.

In the case of detecting a subject existing in the shot image that has not yet been detected by the subject detecting means, the subject detecting means may detect the subject from the one or more detection regions on the basis of a first template image that expresses the subject as viewed from a particular direction.

Consider a subject that exists in a first shot image and has already been detected by the subject detecting means. If that subject is to be detected in another shot image different from the first shot image, then on the basis of the position in the first shot image where the already-detected subject exists, the determining means may additionally determine one or more detection regions in another image pyramid used to detect the subject in the other shot image. The subject detecting means may detect the subject from the one or more detection regions in the other image pyramid on the basis of a plurality of second template images respectively expressing the subject as viewed from a plurality of directions.

An image processing method in accordance with another embodiment of the present invention is executed in an image processing apparatus configured to detect one or more subjects set as detection targets from a shot image acquired by imaging. The image processing apparatus includes: generating means; determining means; and subject detecting means. The method includes the steps of: causing the generating means to generate an image pyramid used to detect the one or more subjects, wherein the image pyramid is generated by reducing or enlarging the shot image using scales set in advance according to the distance from the imaging unit that conducts the imaging to the one or more subjects to be detected; causing the determining means to determine, from among the entire image regions in the image pyramid, one or more detection regions for detecting the one or more subjects; and causing the subject detecting means to detect the one or more subjects from the one or more detection regions.

According to an embodiment of the present invention like those described above, an image pyramid used to detect one or more subjects is generated. The image pyramid is generated by reducing or enlarging the shot image using scales set in advance according to the distance from the imaging unit that conducts the imaging to the one or more subjects to be detected. From among the entire image regions in the image pyramid, one or more detection regions for detecting the one or more subjects are determined. The one or more subjects are then detected from the one or more detection regions.

An electronic device in accordance with another embodiment of the present invention is configured to detect one or more subjects set as detection targets from a shot image acquired by imaging, and conduct processing based on the detection results. The electronic device includes: generating means for generating an image pyramid used to detect the one or more subjects, wherein the image pyramid is generated by reducing or enlarging the shot image using scales set in advance according to the distance from the imaging unit that conducts the imaging to the one or more subjects to be detected; determining means for determining, from among the entire image regions in the image pyramid, one or more detection regions for detecting the one or more subjects; and subject detecting means for detecting the one or more subjects from the one or more detection regions.

According to an embodiment of the present invention like that described above, an image pyramid used to detect one or more subjects is generated. The image pyramid is generated by reducing or enlarging the shot image using scales set in advance according to the distance from the imaging unit that conducts the imaging to the one or more subjects to be detected. From among the entire image regions in the image pyramid, one or more detection regions for detecting the one or more subjects are determined. The one or more subjects are then detected from the one or more detection regions, and processing based on the detection results is conducted.

Thus, according to an embodiment of the present invention, it becomes possible to detect a human face or other subject from a shot image more quickly and with less computation.

### BRIEF DESCRIPTION OF THE DRAWINGS

FIGS. 1A and 1B are diagrams for explaining an overview of embodiments of the present invention;

FIG. 2 is a block diagram illustrating an exemplary configuration of an image processing apparatus in accordance with the first embodiment;

FIG. 3 is a first diagram for explaining a generation process for generating an image pyramid;

FIG. 4 is a second diagram for explaining a generation process for generating an image pyramid;

FIGS. 5A and 5B are diagrams for explaining one example of a first determination process for determining detection regions;

FIGS. 6A and 6B illustrate an example of a face detection template;

FIGS. 7A and 7B are diagrams for explaining a face detection process;

FIG. 8 is a flowchart for explaining a first subject detection process;

FIG. 9 is a diagram for explaining one example of a second determination process for determining detection regions;

FIG. 10 is a block diagram illustrating an exemplary configuration of an image processing apparatus in accordance with the second embodiment;

FIGS. 11A to 11C are diagrams for explaining a background subtraction process;

FIG. 12 is a diagram for explaining a background renewal process;

FIG. 13 is a diagram for explaining one example of a third determination process for determining detection regions;

FIG. 14 is a flowchart for explaining a second subject detection process;

FIG. 15 illustrates one example of how a moving body threshold value used in a frame subtraction process varies according to the frame rate;

FIG. 16 is a block diagram illustrating an exemplary configuration of an image processing apparatus in accordance with the third embodiment;

FIG. 17 is a diagram for explaining one example of a fourth determination process for determining detection regions;

FIG. 18 is a flowchart for explaining a third subject detection process;

FIG. 19 is a diagram for explaining how a process ends once a predetermined number of subjects has been detected;

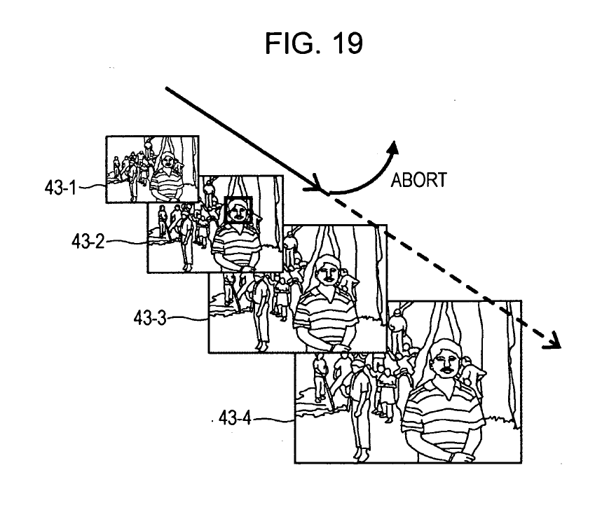

FIG. 20 is a diagram for explaining how subject detection is conducted while excluding detection regions in which a previously detected subject exists;

FIGS. 21A to 21D are diagrams for explaining how comparison regions to be compared with a template are extracted from a detection region;

FIG. 22 is a block diagram illustrating an exemplary configuration of a display control apparatus in accordance with the fourth embodiment;

FIG. 23 illustrates one example of how moving body region information is output prior to analysis results with respect to the state of a subject; and

FIG. 24 is a block diagram illustrating an exemplary configuration of a computer.

### DESCRIPTION OF THE PREFERRED EMBODIMENTS

Hereinafter, embodiments for carrying out the invention (hereinafter referred to as embodiments) will be described. The description will proceed as follows.

1. Overview of embodiments

2. First embodiment (example of determining detection regions from camera orientation)

3. Second embodiment (example of determining detection regions from moving body in shot images)

4. Third embodiment (example of determining detection regions from distance to subject)

5. Modifications

6. Fourth embodiment (example of display control apparatus including image processor that detects subject)

### 1. Overview of Embodiments

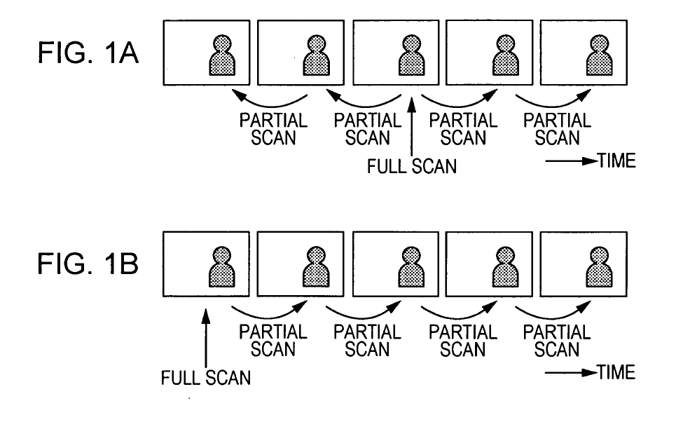

An overview of the embodiments will now be described with reference to FIGS. 1A and 1B.

In the embodiments described herein, a subject detection process is conducted, wherein one or more subjects set as detection targets, such as human faces, are detected from a motion image made up of a plurality of shot images.

In other words, in the embodiments described herein, a full scan is conducted to detect all subjects present in the shot images. The full scan is conducted at a frequency of one frame per several frames (or fields) of the shot images that make up the motion image.

In addition, in the embodiments described herein, partial scans are conducted after the full scan. The partial scans detect the one or more subjects that were detected by the full scan. Furthermore, the partial scans detect the one or more subjects from other shot images that differ from the shot images subjected to the full scan.

More specifically, FIG. 1A illustrates the case where, for example, one or more subjects are detected from shot images that make up a previously recorded motion image. As shown in FIG. 1A, a full scan for detecting all subjects in a shot image is conducted once every five frames. In addition, partial scans for detecting the one or more subjects detected by the full scan are also conducted. The partial scans detect the one or more subjects from the shot images corresponding to the two frames both preceding and succeeding the full scan frame.

FIG. 1B illustrates another case where, for example, one or more subjects are detected from shot images that are successively input from a camera without being recorded. As shown in FIG. 1B, a full scan for detecting all subjects in a shot image is conducted once every five frames. In addition, partial scans for detecting the one or more subjects detected by the full scan are also conducted. The partial scans detect the one or more subjects from each of the shot images corresponding to the four frames succeeding the full scan frame.

Hereinafter, the first through the third embodiments are described for the case of successively detecting subjects from shot images acquired by camera imaging. However, it should appreciated that the first through the third embodiments may also detect subjects by means of similar processes for the case of detecting subjects from a previously recorded motion image. However, since such processes are similar to those for the case of detecting subjects from shot images acquired by camera imaging, further description of such processes is hereinafter omitted.

### 2. First Embodiment

Exemplary configuration of image processing apparatus 1

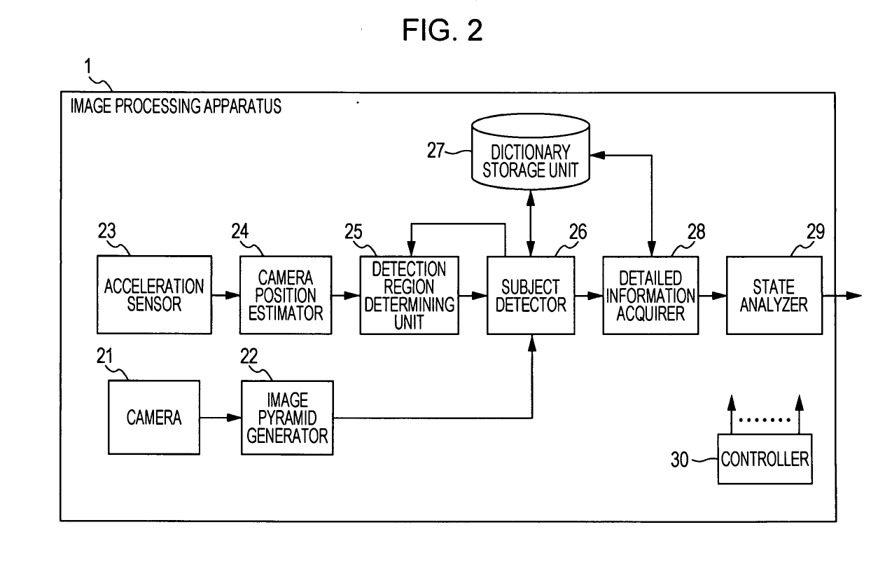

FIG. 2 illustrates an exemplary configuration of an image processing apparatus 1 in accordance with the first embodiment.

The image processing apparatus 1 is provided with a camera 21, an image pyramid generator 22, an acceleration sensor 23, a camera position estimator 24, a detection region determining unit 25, a subject detector 26, a dictionary storage unit 27, a detailed information acquirer 28, a state analyzer 29, and a controller 30.

The camera 21 conducts imaging, and supplies the shot image obtained as a result to the image pyramid generator 22. At this point, the orientation of the camera 21 is changed in accordance with instructions from the controller 30.

On the basis of a shot image from the camera 21, the image pyramid generator 22 generates an image pyramid. The image pyramid is made up of a plurality of pyramid images which are used to detect a subject, such as human faces, for example. It should be appreciated that the target subject to be detected is not limited to being human faces, and that it is also possible to detect features such as human hands or feet, as well as vehicles such as automobiles. However, the first through the third embodiments herein are described for the case of detecting human faces.

### Exemplary Generation Process for Generating Image Pyramid

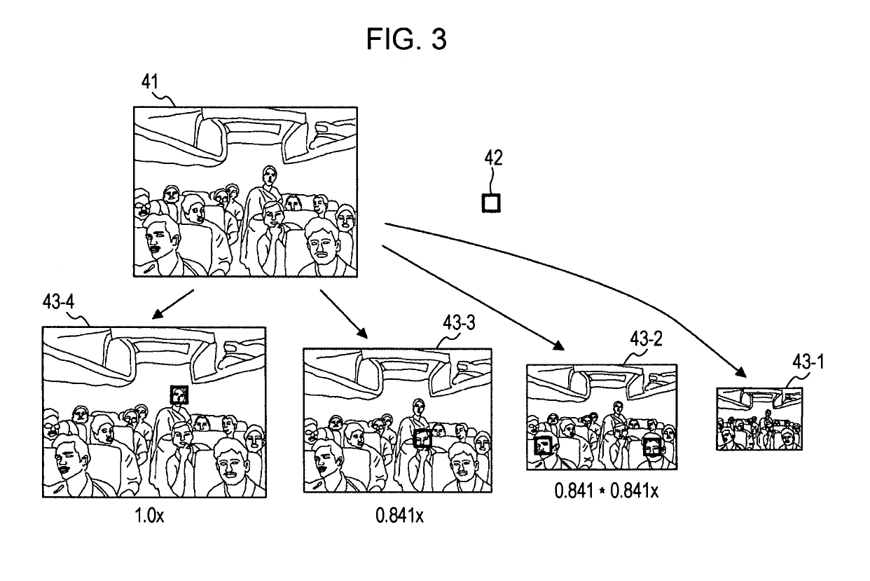

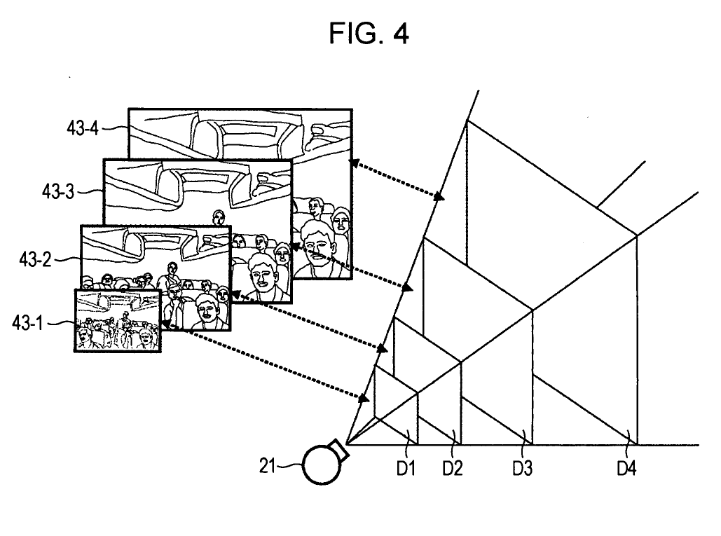

A generation process whereby the image pyramid generator 22 generates a plurality of pyramid images will now be described with reference to FIGS. 3 and 4.

FIG. 3 illustrates one example of a plurality of pyramid images 43-1 to 43-4, which were obtained by reducing (or enlarging) a shot image 41 from the camera 21 at respectively different scales.

As shown in FIG. 3, a plurality of target faces to be detected are displayed in the shot image 41. In the shot image 41, faces closer to the camera 21 appear larger.

In order to detect faces at a predetermined distance from the camera 21, the target faces to be detected should be similar in size to the template size of a template 42. The template 42 expresses an image for face detection, against which the target faces are compared.

Thus in order to make the sizes of the target faces similar to the template size, the image pyramid generator 22 generates the pyramid images 43-1 to 43-4 by respectively reducing or enlarging the shot image 41. The scales at which the shot image 41 is reduced or enlarged are preset according to the respective distances from the camera 21 to the target faces (in FIG. 3, the shot image 41 is reduced at the scales 1.0×, 0.841×, and 0.841*0.841×, for example).

FIG. 4 illustrates one example of how the shot image 41 may be reduced at scales preset according to the respective distances to the target faces.

As shown in FIG. 4, in the first case, one of the detection targets is a face existing in the spatial range D1 closest to the camera 21. In this case, the image pyramid generator 22 reduces the shot image 41 at a scale in accordance with the distance from the camera 21 to the target face, and thereby generates the pyramid image 43-1.

In the second case, one of the detection targets is a face existing in the spatial image range D2, which is farther away from the camera 21 than the spatial range D1. In this case, the image pyramid generator 22 reduces the shot image 41 at a scale in accordance with the distance from the camera 21 to the target face (0.841*0.841× in this case), and thereby generates the pyramid image 43-2.

In the third case, one of the detection targets is a face existing in the spatial image range D3, which is farther away from the camera 21 than the spatial range D2. In this case, the image pyramid generator 22 reduces the shot image 41 at a scale in accordance with the distance from the camera 21 to the target face (0.841× in this case), and thereby generates the pyramid image 43-3.

In the fourth case, one of the detection targets is a face existing in the spatial image range D4, which is farther away from the camera 21 than the spatial range D2. In this case, the image pyramid generator 22 reduces the shot image 41 at a scale in accordance with the distance from the camera 21 to the target face (1.0× in this case), and thereby generates the pyramid image 43-4.

In the description hereinafter, when there is no particular distinction to be made among the pyramid images 43-1 to 43-4, the pyramid images 43-1 to 43-4 will simply be referred to as the image pyramid 43.

The image pyramid generator 22 supplies the generated image pyramid 43 (made up of the plurality of pyramid images 43-1 to 43-4, for example) to the subject detector 26.

Returning to FIG. 2, an acceleration sensor 23 is provided in the camera 21. The acceleration sensor 23 detects acceleration produced in the camera 21 (or information indicating such acceleration), and supplies the acceleration to the camera position estimator 24.

On the basis of the acceleration from the acceleration sensor 23, the camera position estimator 24 estimates the orientation of the camera 21, and supplies the estimation results to the detection region determining unit 25.

In the image processing apparatus 1 herein, an angular velocity sensor or similar component may also be implemented instead of the acceleration sensor 23. In this case, the camera position estimator 24 estimates the orientation of the camera 21 on the basis of the angular velocity from the angular velocity sensor.

When conducting a full scan, the detection region determining unit 25 uses the estimation results from the camera position estimator 24 as a basis for determining detection regions used to detect faces within the image pyramid 43.

Consider the example wherein, on the basis of the estimation results from the camera position estimator 24, the detection region determining unit 25 determines that the orientation of the camera 21 is changing with time (the camera 21 may be panning, for example). In this case, the full scan detection regions are determined as follows.

For the part of the image pyramid 43 used to detect target faces that are distant from the camera 21 (such as the pyramid image 43-4, for example), the detection region determining unit 25 determines the detection region to be the central region within the image pyramid 43. For all other parts of the image pyramid 43 (such as the pyramid images 43-1 to 43-3, for example), the detection region determining unit 25 determines the detection regions to be the entire region within the image pyramid 43.

Consider another example wherein, on the basis of the estimation results from the camera position estimator 24, the detection region determining unit 25 determines that the orientation of the camera 21 is fixed in a particular direction. Furthermore, assume that the particular direction of the camera 21 is indeterminate. In this case, the full scan detection regions are determined as follows.

For a set amount of time, the detection region determining unit 25 determines the full scan detection regions to be all regions in the image pyramid 43. In addition, the detection region determining unit 25 computes the probabilities of a human face appearing in respective regions within the image pyramid 43. The detection region determining unit 25 then determines the final detection regions by gradually narrowing the scope of regions in the image pyramid 43 so as to exclude regions whose computed probability fails to satisfy a given threshold value.

Herein, the probability of a human face appearing in a given region is computed by the detection region determining unit 25 on the basis of the positions of faces in the shot image (or information indicating such positions). Such face positions are included in the detailed information, which is acquired by the detailed information acquirer 28 to be hereinafter described.

As another example, the detection region determining unit 25 may also determine the detection regions by utilizing subject information included in the detailed information. Such subject information may express human postures, ages, heights, or other information. In other words, on the basis of postures or heights included in the subject information, the detection region determining unit 25 may predict the regions of the shot image 41 where human faces to be detected are likely to appear. (For example, if a person's height is tall, then the detection region determining unit 25 may predict that the person's face is likely to appear in the upper regions of the shot image 41.) The detection region determining unit 25 may then determine the detection regions to be the predicted regions.

Consider another example wherein, on the basis of the estimation results from the camera position estimator 24, the detection region determining unit 25 determines that the orientation of the camera 21 is fixed in a particular direction. Furthermore, assume that the particular direction of the camera 21 has been determined. In this case, the full scan detection regions are determined according to the orientation of the camera 21.

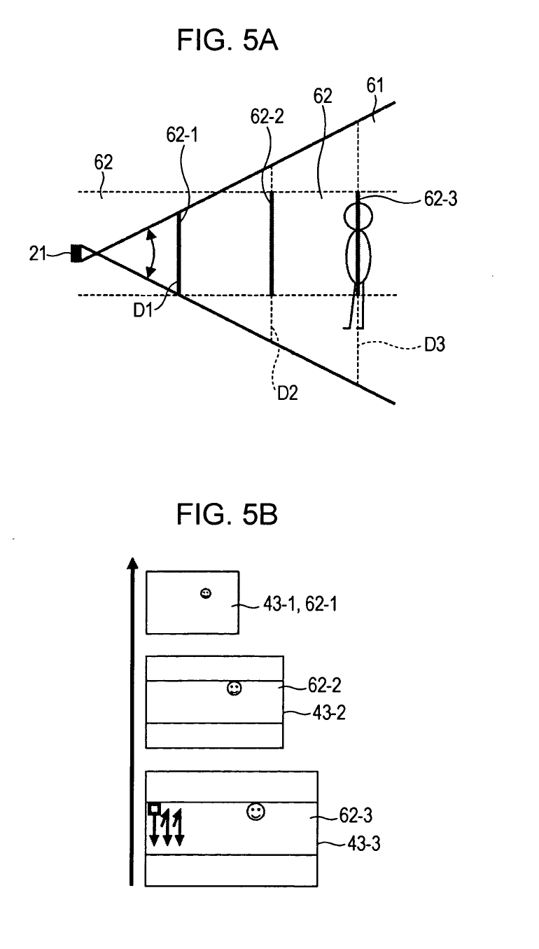

Later, FIGS. 5A and 5B will be used to describe in detail the method for determining the detection regions according to orientation of the camera 21 in the case where the orientation of the camera 21 has been determined to be fixed in a particular direction, and wherein the particular direction of the camera 21 has also been determined.

When conducting a partial scan, the detection region determining unit 25 uses face region information supplied from the subject detector 26 as a basis for determining detection regions used to detect faces in the image pyramid 43. The face region information expresses face regions (i.e., regions where faces exist) in a past shot image that precedes the shot image to be subjected to the partial scan by one frame.

In other words, when conducting a partial scan, the detection region determining unit 25 may determine the partial scan detection regions to be the regions that contain the face regions indicated by the face region information supplied from the subject detector 26, for example.

In addition, when conducting a partial scan, the detection region determining unit 25 may also determine the partial scan detection regions to be the regions that contain the face regions detected by the immediately preceding partial scan.

### Exemplary Determination of Full Scan Detection Regions

FIGS. 5A and 5B illustrate one example of the detection region determining unit 25 determining full scan detection regions on the basis of estimation results from the camera position estimator 24.

Consider the example wherein, on the basis of the estimation results from the camera position estimator 24, the detection region determining unit 25 determines that the orientation of the camera 21 is fixed in a particular direction. Furthermore, assume that the particular direction of the camera 21 has been determined. In this case, the full scan detection regions are determined according to the orientation of the camera 21.

In this example, the detection region determining unit 25 has determined that the orientation of the camera 21 is the state shown in FIG. 5A. Within the imaging range 61 of the camera 21 (i.e., the range delimited by the two lines extending from the camera 21), almost all human faces will exist in the central range 62. Utilizing this parameter, the detection region determining unit 25 determines the detection region within the image pyramid 43 to be the central range 62 (i.e., the region corresponding to the central range 62).

More specifically, consider the example wherein a human face existing in the spatial range D1 is set as the target face to be detected. In this case, the detection region for the central range 62 in the spatial range D1 (i.e., the region corresponding to the central range 62) is determined to be the region 62-1 within the pyramid image 43-1, as shown in FIGS. 5A and 5B.

Consider another example wherein a human face existing in the spatial range D2 is set as the target face to be detected. In this case, the detection region for the central range 62 in the spatial range D2 is determined to be the region 62-2 within the pyramid image 43-2, as shown in FIGS. 5A and 5B.

Consider another example wherein a human face existing in the spatial range D3 is set as the target face to be detected. In this case, the detection region for the central range 62 in the spatial range D3 is determined to be the region 62-3 within the pyramid image 43-3, as shown in FIGS. 5A and 5B. Meanwhile, the detection region for the spatial range D4 is similarly determined to be a region within the pyramid image 43-4.

The detection region determining unit 25 then supplies the subject detector 26 with detection region information, which expresses the detection regions (such as the detection regions 62-1 to 62-3, for example) that have been determined with respect to the image pyramid 43.

Returning to FIG. 2, the subject detector 26 reads out a face detection template from the dictionary storage unit 27. Subsequently, the subject detector 26 conducts a process to detect faces using the template that was read out. The face detection process is conducted with respect to detection regions within the image pyramid 43 from the image pyramid generator 22. The detection regions are determined on the basis of the detection region information from the detection region determining unit 25.

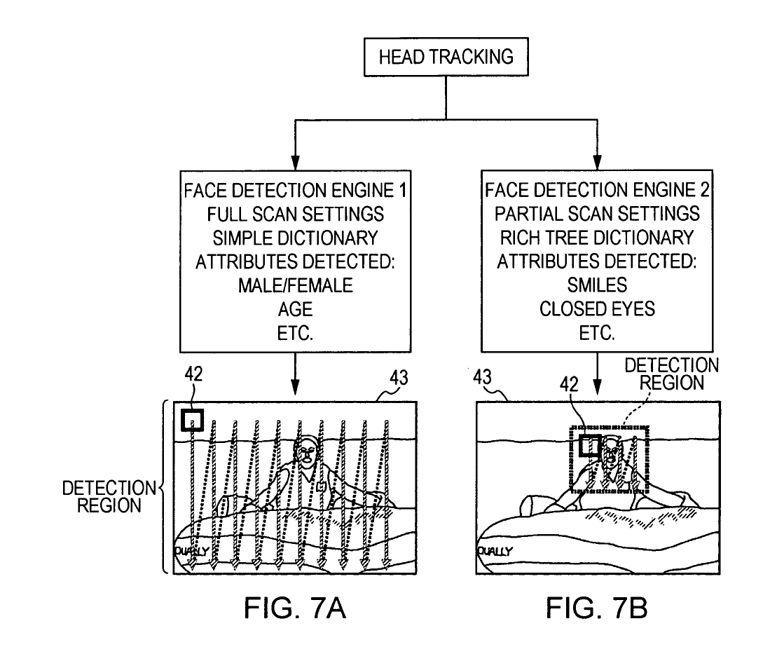

The face detection process conducted by the subject detector 26 will be later described in detail with reference to FIG. 7.

The dictionary storage unit 27 stores face detection templates in advance, in the form of a full scan template and a partial scan template.

### Exemplary Template

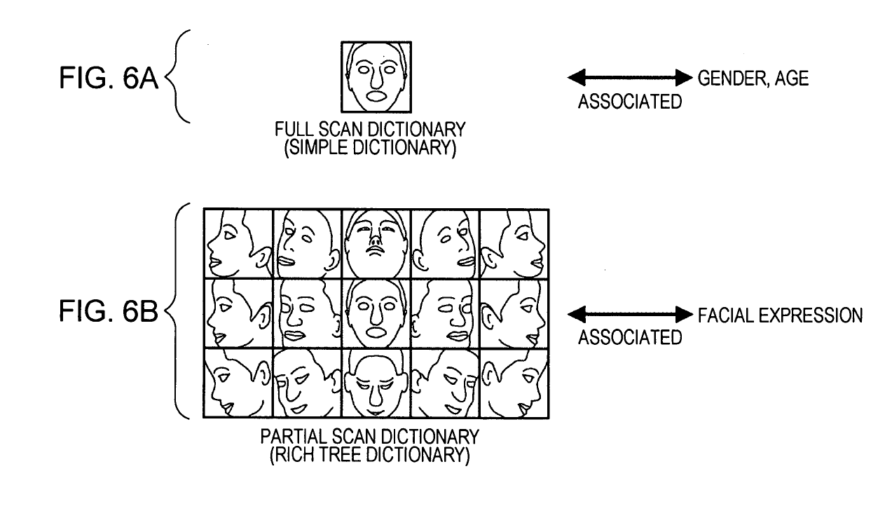

FIGS. 6A and 6B illustrate one example of a full scan template and a partial scan template.

As shown in FIG. 6A, the dictionary storage unit 27 may store a simple dictionary in advance. In the simple dictionary, respective templates are associated with each of a plurality of combinations of genders and ages, with each template expressing a frontal image of an average face for persons matching the corresponding combination of parameters.

As shown in FIG. 6B, the dictionary storage unit 27 may also store a rich tree dictionary in advance. In the tree, respectively different facial expressions are each associated with a plurality of templates that express images of average faces with the corresponding facial expression viewed from multiple angles.

Meanwhile, a simple dictionary is used when conducting a full scan. In addition to face detection, the simple dictionary is also used to detect face attributes that do not change from shot image to shot image. Such attributes may include the person's gender and age, for example. The rich tree dictionary is used when conducting a partial scan. In addition to face detection, the rich tree dictionary is used to detect attributes that (may easily) change from shot image to shot image. Such attributes may include the facial expression, for example.

### Exemplary Face Detection Process

FIGS. 7A and 7B will now be used to describe in detail the face detection process conducted by the subject detector 26 using templates stored in the dictionary storage unit 27.

Consider the case where the subject detector 26 conducts a full scan to detect all faces in an image pyramid 43 corresponding to a shot image 41. In this case, as shown in FIG. 7A, the subject detector 26 uses a template 42 (the simple dictionary template illustrated in FIG. 6A, for example) to detect faces in targeted detection regions within the image pyramid 43.

Consider now the case where the subject detector 26 conducts a partial scan to detect the faces detected by the full scan from an image pyramid 43 corresponding to another shot image 41. In this case, as shown in FIG. 7B, the subject detector 26 uses a template 42 (such as a template in the rich tree dictionary illustrated in FIG. 6B) to detect faces in targeted detection regions within the image pyramid 43.

In either case, if the subject detector 26 detects one or more faces by means of the full scan or partial scan face detection process, then the subject detector 26 supplies the detection region determining unit 25 and the detailed information acquirer 28 with face region information, which expresses one or more face regions within the image pyramid 43.

In addition, the subject detector 26 also supplies the detailed information acquirer 28 with the templates that were used to detect the one or more faces.

Returning to FIG. 2, the detailed information acquirer 28 acquires detailed information about the one or more faces existing within the shot image 41 on the basis of the face region information and templates received from the subject detector 26. In other words, the detailed information acquirer 28 may, for example, determine the positions of the one or more faces in the shot image 41 on the basis of the face region information from the subject detector 26, and then supply this position information to the state analyzer 29 as detailed information.

As another example, the detailed information acquirer 28 may also read out information from the dictionary storage unit 27 that is associated with the templates received from the subject detector 26. Such information may include gender, age, and facial expression information, for example. The detailed information acquirer 28 then supplies this information to the state analyzer 29 as detailed information.

On the basis of the detailed information from the detailed information acquirer 28, the state analyzer 29 analyzes the state (i.e., appearance) of the subject, and then outputs the analysis results.

The controller 30 controls the components from the camera 21 to the state analyzer 29. From among the shot images acquired by the camera 21, the controller 30 causes a full scan to be conducted at a frequency of one frame per several frames, while also causing partial scans to be conducted with respect to the remaining frames.

### Operation of First Subject Detection Process

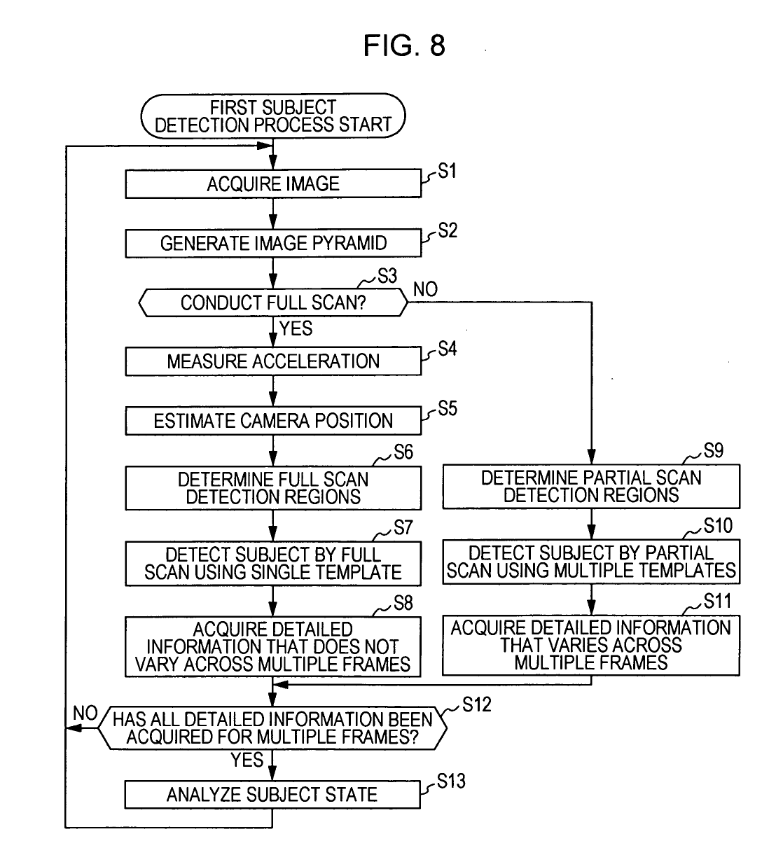

The flowchart in FIG. 8 will now be used to describe in detail a first subject detection process conducted by the image processing apparatus 1.

In step S1, the camera 21 shoots (i.e., acquires images), and supplies the image pyramid generator 22 with a shot image 41 acquired as a result.

In step S2, the image pyramid generator 22 generates an image pyramid 43 (i.e., a plurality of pyramid images) on the basis of the shot image 41 from the camera 21. The image pyramid 43 may be used to detect human faces, and may be generated in the manner described with reference to FIGS. 3 and 4, for example. The generated image pyramid 43 is supplied to the subject detector 26.

In step S3, the controller 30 determines whether or not to conduct a full scan. This determination is made on the basis of the number of shot images that have been acquired by the imaging of the camera 21.

In step S3, if the controller 30 determines to conduct a full scan on the basis of the number of shot images acquired by the imaging of the camera 21, then the process proceeds to step S4.

In step S4 to step S8, the components from the acceleration sensor 23 to the detailed information acquirer 28 follow instructions from the controller 30 to detect one or more faces by means of a full scan. Detailed information obtained from the detection results is also acquired.

In other words, in step S4, the acceleration sensor 23 detects acceleration produced in the camera 21 (or information indicating such acceleration), and supplies the acceleration to the camera position estimator 24.

In step S5, the detection region determining unit 25 estimates the orientation of the camera 21 on the basis of the acceleration from the acceleration sensor 23, and supplies the estimation results to the detection region determining unit 25.

In step S6, the detection region determining unit 25 determines one or more full scan detection regions on the basis of the estimation results from the camera position estimator 24.

In step S7, the subject detector 26 detects faces in the one or more detection regions determined by the processing in step S6. The subject detector 26 detects faces by using a corresponding template (i.e., the simple dictionary in FIG. 7A) for each of a plurality of combinations of factors (such as gender and age).

If the subject detector 26 detects one or more faces by means of the face detection process, then the subject detector 26 supplies the detection region determining unit 25 and the detailed information acquirer 28 with face region information indicating one or more face regions within the image pyramid 43.

In addition, the subject detector 26 supplies the detailed information acquirer 28 with the templates that were used to detect the one or more faces.

In step S8, the detailed information acquirer 28 accesses the dictionary storage unit 27 and reads out information associated with the templates received from the subject detector 26. Such information may include gender and age information, for example. In addition, on the basis of the face region information from the subject detector 26, the detailed information acquirer 28 determines the positions of one or more human faces in the shot image 41.

The detailed information acquirer 28 then supplies detailed information to the state analyzer 29. The detailed information may include the read-out gender and age information, as well as the determined positions of the one or more human faces, for example. The process then proceeds to step S12.

The processing in step S12 will be described after first describing the processing in step S9 to step S11.

In step S3, if the controller 30 determines to not conduct a full scan on the basis of the number of shot images acquired by the imaging of the camera 21, then the process proceeds to step S9. In the other words, the process proceeds to step S9 when the controller 30 determines to conduct a partial scan.

In step S9 to step S11, the components from the detection region determining unit 25 to the detailed information acquirer 28 follow instructions from the controller 30 to detect the one or more faces detected by the full scan by means of a partial scan. Detailed information obtained from the detection results is also acquired.

In other words, in step S9, the detection region determining unit 25 determines partial scan detection regions on the basis of the face region information supplied from the subject detector 26 in the processing of the previous steps S7 or S11.

More specifically, the detection region determining unit 25 may determine the partial scan detection regions to be, for example, regions within the image pyramid 43 that contain the one or more face regions indicated by the face region information supplied from the subject detector 26.

In step S10, the subject detector 26 detects faces in the detection regions determined by the processing in step S9. The subject detector 26 detects faces by using the corresponding templates (i.e., the rich tree dictionary in FIG. 7B) for each of a plurality of respectively different facial expressions.

If the subject detector 26 detects one or more faces by means of the face detection process, then the subject detector 26 supplies the detection region determining unit 25 and the detailed information acquirer 28 with face region information indicating one or more regions within the image pyramid 43 wherein faces exist.

In addition, the subject detector 26 supplies the detailed information acquirer 28 with the templates that were used to detect the one or more faces.

In step S11, the detailed information acquirer 28 accesses the dictionary storage unit 27 and reads out information associated with the templates received from the subject detector 26. Such information may include facial expressions (or information indicating such expressions), for example. In addition, on the basis of the face region information from the subject detector 26, the detailed information acquirer 28 determines the positions of one or more human faces in the shot image 41.

The detailed information acquirer 28 then supplies detailed information to the state analyzer 29. The detailed information may include the read-out facial expressions, as well as the determined positions of the one or more human faces, for example. The process then proceeds to step S12.

In step S12, the state analyzer 29 determines whether or not all detailed information has been acquired from the detailed information acquirer 28 for each of a predetermined plurality of shot images. (For example, the predetermined plurality of shot images may include one shot image subject to a full scan, and four shot images subjected to partial scans, as shown in FIG. 1B.) In other words, the state analyzer 29 determines whether or not detailed information sufficient for analyzing the state of the subject has been acquired.

In step S12, if the state analyzer 29 determines that not all detailed information has been acquired from the detailed information acquirer 28 for the predetermined plurality of shot images, then the process returns to step S1, and a process similar to the above is conducted thereafter.

In contrast, in step S12, if the state analyzer 29 determines that all detailed information has been acquired from the detailed information acquirer 28 for the predetermined plurality of shot images, then the process proceeds to step S13.

In step S13, the state analyzer 29 analyzes the state (i.e., the appearance) of the subject on the basis of the plurality of detailed information from the detailed information acquirer 28, and outputs the analysis results. Subsequently, the process returns to step S1, and a process similar to the above is conducted thereafter.

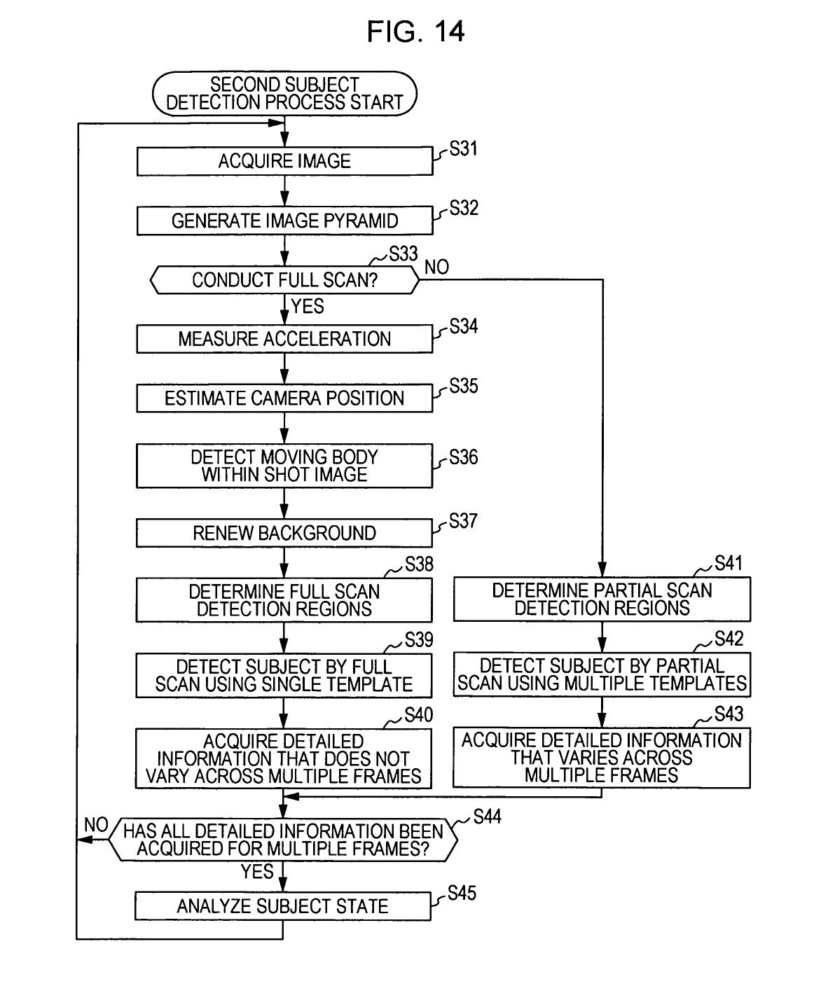

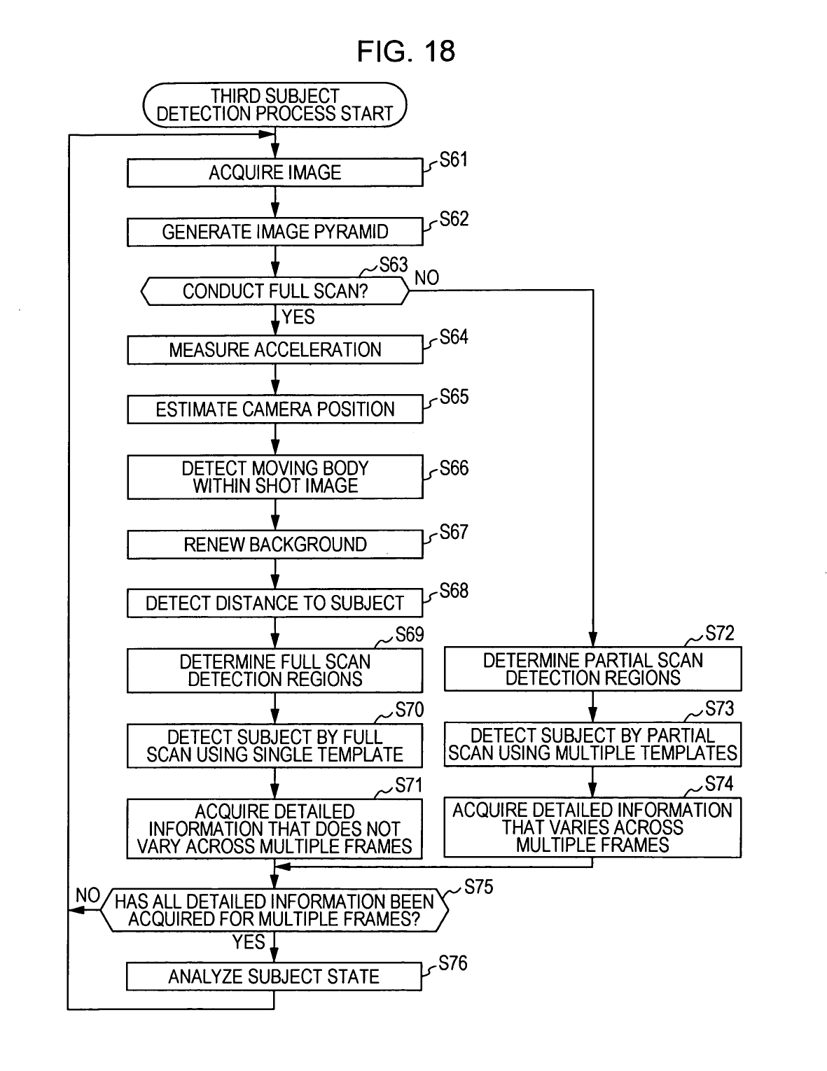

Herein, the first subject detection process may be terminated when the image processing apparatus 1 is powered off by a user operation, for example. The second and third subject detection processes to be hereinafter described (see FIGS. 14 and 18) may be similarly terminated.

As described above, when a full scan is conducted according to the first subject detection, process, the detection region determining unit 25 uses the orientation of the camera 21 as a basis for determining detection regions. The detection regions are determined to be predefined regions from among the regions in the image pyramid 43.

In addition, when conducting a partial scan, the detection region determining unit 25 determines the detection regions to be regions that contain face regions detected in a previous scan.

A full scan is more processor intensive than a partial scan, and thus in step S7 of the first subject detection process, a simple dictionary is used. Using a simple dictionary is less processor intensive compared to using a rich tree dictionary, for example. Furthermore, a full scan is conducted at a frequency of once per several frames.

Meanwhile, a rich tree dictionary is used in step S10 when conducting a partial scan. Although using a rich tree dictionary is more processor intensive compared to used a simple dictionary, for example, the use of a rich tree dictionary enables free tracking of faces from multiple angles.

Consequently, according to the first subject detection process, it becomes possible to detect subjects more quickly and accurately and with less computation as compared to the case of setting the detection regions to be all regions in the image pyramid 43 for every frame.

In the first embodiment herein, the camera 21 is described as changing in orientation according to instructions from the controller 30. However, it should be appreciated that the camera implemented as the camera 21 may also be a stationary camera whose orientation is fixed in a given direction.

In this case, the acceleration sensor 23 and the camera position estimator 24 may be omitted from the configuration. The detection region determining unit 25 may then determine the full scan detection regions by one of two methods: the detection region determination method for the case wherein the orientation of the camera 21 is fixed in a particular but indeterminate direction; and the detection region determination method for the case wherein the orientation of the camera 21 is fixed in a particular direction that has been determined (see FIGS. 5A and 5B).

In addition, when conducting a full scan, the detection region determining unit 25 is herein configured to determine the full scan detection regions on the basis of estimation results from the camera position estimator 24. However, the detection region determining unit 25 may also determine the detection regions to be other regions, such as regions preset by the user, for example.

When conducting a full scan, it is also possible for the detection region determining unit 25 to determine the full scan detection regions irrespectively of the orientation of the camera 21.

### Exemplary Determination of Detection Regions

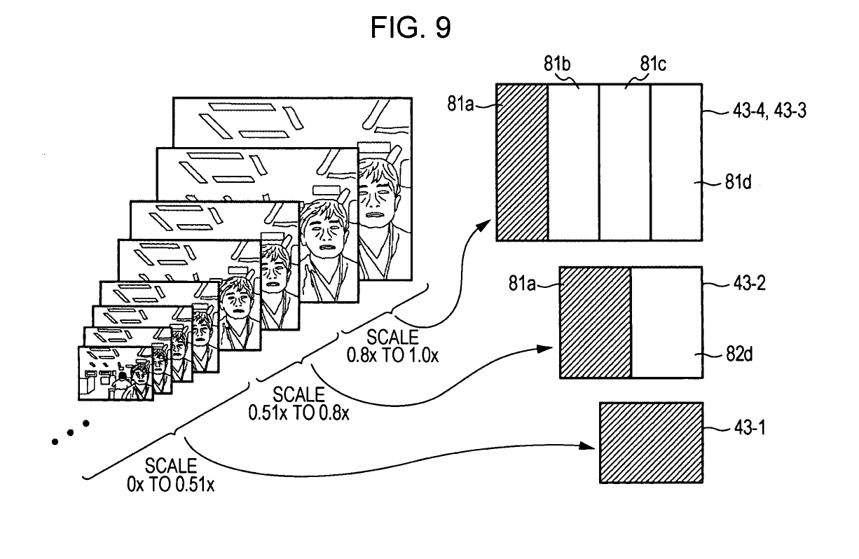

FIG. 9 illustrates one example of determining full scan detection regions irrespectively of the orientation of the camera 21.

As shown in FIG. 9, the detection region determining unit 25 first takes one or more pyramid images from the image pyramid 43 that have been scaled using reduction factors between 0.8× and 1.0× inclusive. The detection region determining unit 25 then subdivides those pyramid images into a plurality of regions (four, for example), and successively sets those regions as detection regions each time a full scan is conducted.

More specifically, the detection region determining unit 25 may subdivide the pyramid images 43-3 and 43-4 into the four regions 81a to 81d, for example. Subsequently, each time a full scan is conducted, the detection region determining unit 25 sets the detection regions in the following order: regions 81a, region 81b, region 81c, region 81d, region 81a, and so on.

Also, as shown in FIG. 9, the detection region determining unit 25 also takes one or more pyramid images from the image pyramid 43 that have been scaled using factors at or above 0.51× but less than 0.8×. The detection region determining unit 25 then subdivides those pyramid images into a plurality of regions (two, for example), and successively sets those regions as detection regions each time a full scan is conducted.

More specifically, the detection region determining unit 25 may subdivide the pyramid image 43-2 into the two regions 82a and 82b, for example. Subsequently, each time a full scan is conducted, the detection region determining unit 25 sets the detection regions in the following order: regions 82a, region 82b, region 82a, and so on.

In addition, as shown in FIG. 9, the detection region determining unit 25 also takes one or more pyramid images from the image pyramid 43 that have been scaled using factors at or above 0× but less than 0.51×. The detection region determining unit 25 then sets the full regions of those pyramid images as detection regions.

More specifically, each time a full scan is conducted, the detection region determining unit 25 may set the entire region within the pyramid image 43-1 as a detection region.

According to the detection region determination method described with reference to FIG. 9, detection regions can be determined irrespectively of the orientation of the camera 21. In this case, the processing in step S4 (detecting acceleration produced in the camera 21) and step S5 (estimating the orientation of the camera 21) of the first subject detection process can be omitted. For this reason, it becomes possible to execute the subject detection process more quickly.

Herein, the image processing apparatus 1 that detects one or more subjects from a shot image 41 may also be invoked as a result of the user performing a recognized gesture or similar operation in front of the camera 21, for example.

In such cases, the user will usually perform the gesture operation a short distance away from the camera 21. Consequently, in most cases, subjects that are closer to the camera 21 are more important subjects for detection.

Thus, according to the detection region determination method described with reference to FIG. 9, the size of the detection regions within the image pyramid 43 is increased according to the importance the subjects to be detected (i.e., according to how close the subjects are from the camera 21). For this reason, it becomes possible to execute the subject detection process quickly while also curtailing misdetection or under-detection of important subjects.

In the detection region determination method described with reference to FIG. 9, pyramid images in the image pyramid 43 are subdivided into a plurality of regions (such as the regions 81a to 81d), which are then set as the full scan detection regions in a predetermined order. However, it should be appreciated that the present invention is not limited to the above.

In other words, pyramid images in the image pyramid 43 may be subdivided into a plurality of regions, and the frequency whereby each of these regions is set as a detection region may be changed according to the probability that a subject exists in that region, for example. In this case, it becomes possible to improve the probability of detecting a subject compared to the case of subdividing pyramid images in the image pyramid 43 into a plurality of regions, and then setting each of those regions as a detection region in a predetermined order.

Herein, the probability that a subject exists in a given region may be computed on the basis of the positions of faces in a shot image (or information indicating such positions), which is included in the detailed information acquired by the detailed information acquirer 28.

In the first embodiment, detection regions are determined on the basis of the orientation of the camera 21. However, detection regions may also be determined in other ways. For example, a moving body (i.e., a person or object that is moving) may be detected within a shot image 41, and detection regions may then be determined on the basis of that moving body's position in the shot image 41.

### 3. Second Embodiment

### Exemplary Configuration of Image Processing Apparatus 101

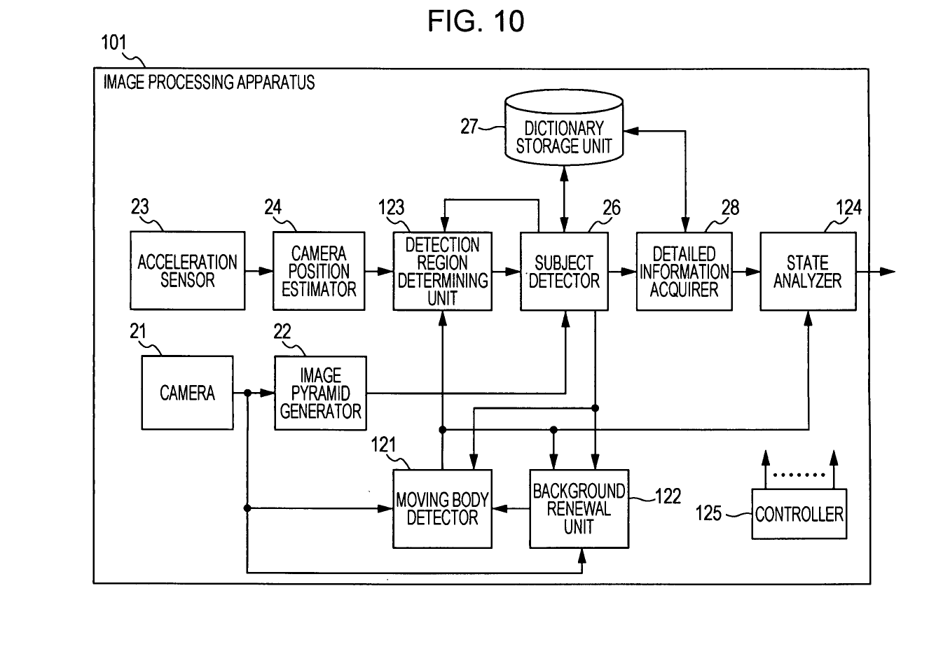

FIG. 10 illustrates an exemplary configuration of an image processing apparatus 101 in accordance with the second embodiment. The image processing apparatus 101 is configured to detect a moving body (i.e., a person or object that is moving) within a shot image 41, and then determine detection regions on the basis of that moving body's position in the shot image 41.

Herein, portions in FIG. 10 that correspond to the first embodiment illustrated in FIG. 2 are given identical reference numbers, and further description of such portions may be hereinafter omitted.

Thus, the image processing apparatus 101 is newly provided with a moving body detector 121 and a background renewal unit 122. In addition, the detection region determining unit 25, the state analyzer 29, and the controller 30 have been replaced by a detection region determining unit 123, a state analyzer 124, and a controller 125, respectively. Otherwise, the second embodiment is configured similarly to the first embodiment.

The moving body detector 121 is respectively supplied with the following: a shot image 41, supplied from the camera 21; face region information for the shot image in the immediately preceding frame, supplied from the subject detector 26; and a background image showing only the background and wherein the subject does not appear, supplied from the background renewal unit 122.

On the basis of the shot image 41 from the camera 21, the face region information from the subject detector 26, and the background image from the background renewal unit 122, the moving body detector 121 detects a moving body in the shot image 41 from the camera 21.

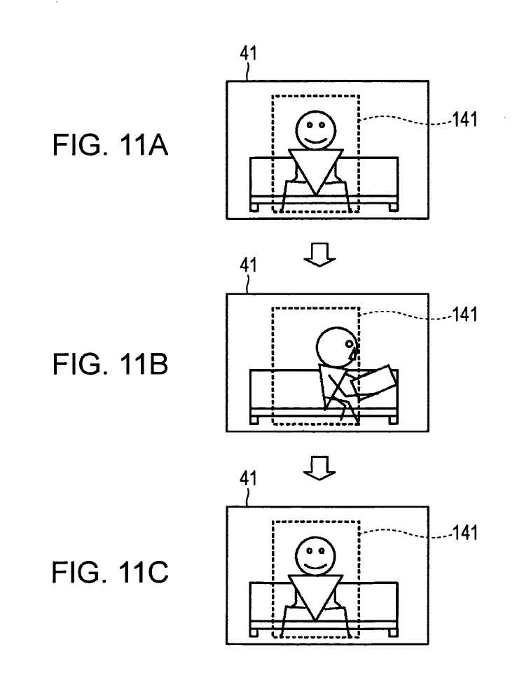

In other words, the moving body detector 121 may conduct a background subtraction process, for example. In the background subtraction process, the moving body detector 121 detects a moving body on the basis of the absolute difference between the shot image 41 from the camera 21 and the background image from the background renewal unit 122, while referring to the face region information from the subject detector 26. This background subtraction process will be later described with reference to FIGS. 11A to 11C.

Besides the background subtraction process described above, a frame subtraction or similar process may also be implemented as the method for detecting a moving body. In a frame subtraction process, a moving body is detected on the basis of the absolute difference between two different shot images 41 from adjacent frames.

### Exemplary Background Subtraction Process

A background subtraction process conducted by the moving body detector 121 will now be described with reference to FIGS. 11A to 11C.

The shot image 41 illustrated in FIG. 11A represents a shot image acquired at a given time. The shot image 41 illustrated in FIG. 11B represents a shot image that precedes the shot image 41 shown in FIG. 11A by one frame. The shot image 41 illustrated in FIG. 11C represents a shot image that precedes the shot image 41 shown in FIG. 11B by one frame.

The moving body detector 121 computes the absolute differences in pixel values for corresponding pixels in the shot images 41 and a background image. If the computed absolute difference values equal or exceed a moving body threshold value for detecting the presence of a moving body, then the moving body detector 121 detects the corresponding regions that satisfy the threshold value as the moving body region.

More specifically, the moving body detector 121 may conduct a background subtraction process using a relatively small moving body threshold value with respect to a subject vicinity region 141, as shown by way of example in FIG. 11A. The subject vicinity region 141 is a region within a shot image 41 that contains a face region indicated by the face region information supplied by the subject detector 26.

A small moving body threshold value is used at this point because there is a high probability that a moving body will exist in the subject vicinity region 141. Using a small moving body threshold value makes it possible to detect slight movements of the moving body, like those illustrated in FIGS. 11A to 11C, for example.

In addition, the moving body threshold value in the subject vicinity region 141 gradually increases with passing time. This is because the probability of the moving body existing in the subject vicinity region 141 decreases with passing time.

Furthermore, the moving body detector 121 may also conduct a background subtraction process using a relatively large moving body threshold value with respect to all regions within the shot image 41 other than the subject vicinity region 141, as shown by way of example in FIGS. 11A to 11C. Such a background subtraction process may be conducted in order to avoid misdetection of a moving body due to noise or other factors.

The moving body detector 121 supplies the background renewal unit 122, the detection region determining unit 123, and the state analyzer 124 with moving body region information, which expresses a moving body region where the detected moving body exists within the image region of the shot image 41.

Returning now to FIG. 10, the background renewal unit 122 is supplied with moving body region information from the moving body detector 121. In addition, the background renewal unit 122 is supplied with a shot image 41 from the camera 21 as well as face region information from the subject detector 26.

On the basis of the face region information from the subject detector 26 and the moving body region information from the moving body detector 121, the background renewal unit 122 determines which regions in the shot image 41 from the camera 21 are regions for the background portion of the image (i.e., background regions), and which regions are regions for portions other than the background portion (such as regions capturing faces or moving bodies, for example).

The background renewal unit 122 then conducts a background renewal process. In the background renewal process, the background renewal unit 122 renews the background image by performing weighted addition of the background regions and the non-background regions using respectively different ratios.

### Explanation of Background Renewal Process

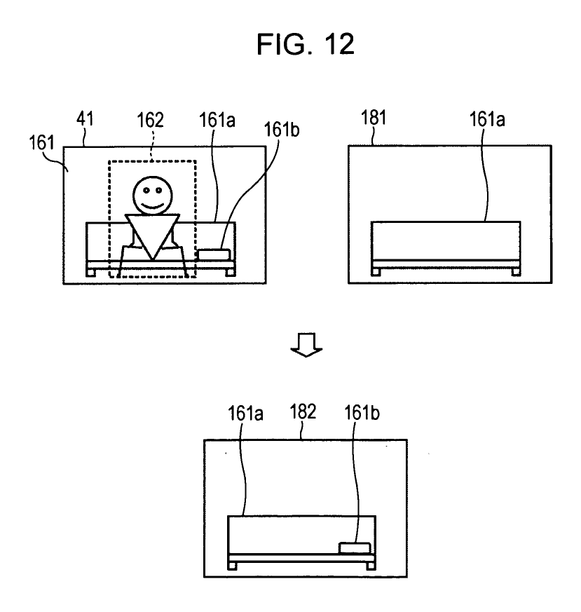

The background renewal process conducted by the background renewal unit 122 to renew the background image will now be described with reference to FIG. 12.

The background renewal unit 122 may be supplied with a shot image 41 from the camera 21 like that shown by way of example in FIG. 12. In this example, the shot image 41 is made up of a background region 161, wherein a table 161a and a remote control 161b are displayed, as well as a region 162, wherein a person is displayed.

As shown by way of example in FIG. 12, the background renewal unit 122 may add a background image 181 displaying the table 161a to the shot image 41 from the camera 21. In so doing, the background renewal unit 122 acquires a renewed background image 182 wherein the remote control 161b is displayed in addition to the table 161a.

In other words, on the basis of the face region information from the subject detector 26 and the moving body region information from the moving body detector 121, the background renewal unit 122 may determine which region within the shot image 41, is the background region 161, and which region is the non-background region 162 (i.e., the region wherein a person or moving body is displayed as the subject).

The background renewal unit 122 applies comparatively large weights to the pixel values of pixels constituting the background region 161 in the shot image 41 from the camera 21, while applying comparatively small weights to the pixel values of pixels constituting the region portions in the background image 181 that correspond to the background region 161.

In addition, the background renewal unit 122 applies comparatively small weights to the pixel values of pixels constituting the non-background region 162 in the shot image from the camera 21, while applying comparatively large weights to the pixel values of pixels constituting the region portions in the background image 181 that correspond to the region 162.

Subsequently, the background renewal unit 122 adds together the corresponding pixel values that were newly obtained by weighting, and sets the pixel values obtained as a result as the pixel values of a new background image 181.

The background renewal unit 122 may also be configured to not add together the non-background region 162 in the shot image 41 from the camera 21 with the region portions in the background image 181 that correspond to the region 162.

At this point, comparatively large weights are applied to the background region 161 on the shot image 41 so that the background region 161 constituting the new background is more greatly reflected in the new background image 181.

In addition, comparatively small weights are applied to the non-background region 162 and added together with the region portions in the background image 181 that correspond to the region 162 in order to prevent the non-background region 162 (which should not become part of the background) from being greatly reflected in the new background image 181.

This is similar to the case of not adding together the non-background region 162 with the region portions in the background image 181 that correspond to the region 162.

Furthermore, the background renewal unit 122 conducts the background renewal process once again using a new shot image 41 from the camera 21 and the new background image 181 obtained by the current background renewal process. In this way, by repeating the background renewal process, the background renewal unit 122 ultimately obtains a renewed background image 182 wherein the remote control 161b is displayed in addition to the table 161a.

Returning now to FIG. 10, when conducting a full scan, the detection region determining unit 123 determines the full scan detection regions on the basis of at least one of the following: estimation results from the camera position estimator 24, or moving body region information from the moving body detector 121.

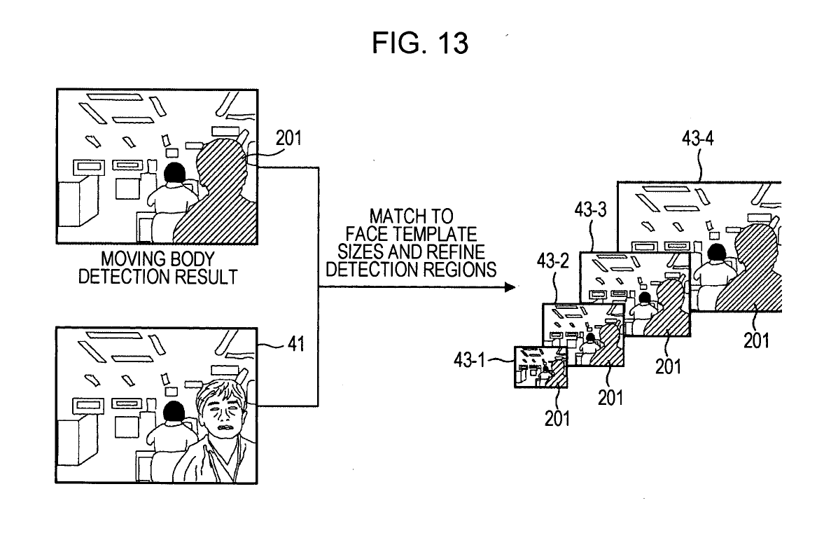

In other words, the detection region determining unit 123 may use the moving body region information from the moving body detector 121 to determine a detection region within the image pyramid 43. The process for setting a moving body region as the detection region will be later described in detail with reference to FIG. 13.

As another example, the detection region determining unit 123 may also be configured to determine detection regions on the basis of estimation results for the orientation of the camera 21 supplied from the camera position estimator 24, similarly to the first embodiment.

As another example, it is also possible for the detection region determining unit 123 to first determine a detection region on the basis of estimation results from the camera position estimator 24, and also determine a detection region on the basis of moving body region information from the moving body detector 121. The detection region determining unit 123 may then determine the final detection region to be the combined region portions from the regions determined above.

When conducting a partial scan, the detection region determining unit 123 may determine partial scan detection regions on the basis of face region information supplied from the subject detector 26 for a shot image that precedes the shot image being subjected to the partial scan by one frame, similar to the first embodiment.

### Exemplary Determination of Detection Regions on the Basis of Moving Body Region

FIG. 13 illustrates the details of a process whereby the detection region determining unit 123 determines a partial scan detection region on the basis of moving body region information from the moving body detector 121.

As shown on the left side of FIG. 13, the detection region determining unit 123 determines the detection region to be a moving body region 201 expressed by moving body region information from the moving body detector 121. The detection region determining unit 123 then supplies the subject detector 26 with detection region information indicating the determined detection region.

As shown on the right side of FIG. 13, as a result of the above, the subject detector 26 uses the detection region information supplied from the detection region determining unit 123 as a basis for conducting a face detection process, wherein the respective moving body regions 201 in the pyramid images 43-1 to 43-4 are set as the detection regions.

Returning now to FIG. 10, the state analyzer 124 analyzes the state of the subject on the basis of detailed information from the detailed information acquirer 28, and then outputs the analysis results. In addition, in cases where the processing to analyze the state of the subject involves a large amount of time, the state analyzer 124 also outputs the moving body region information from the moving body detector 121 prior to outputting the analysis results.

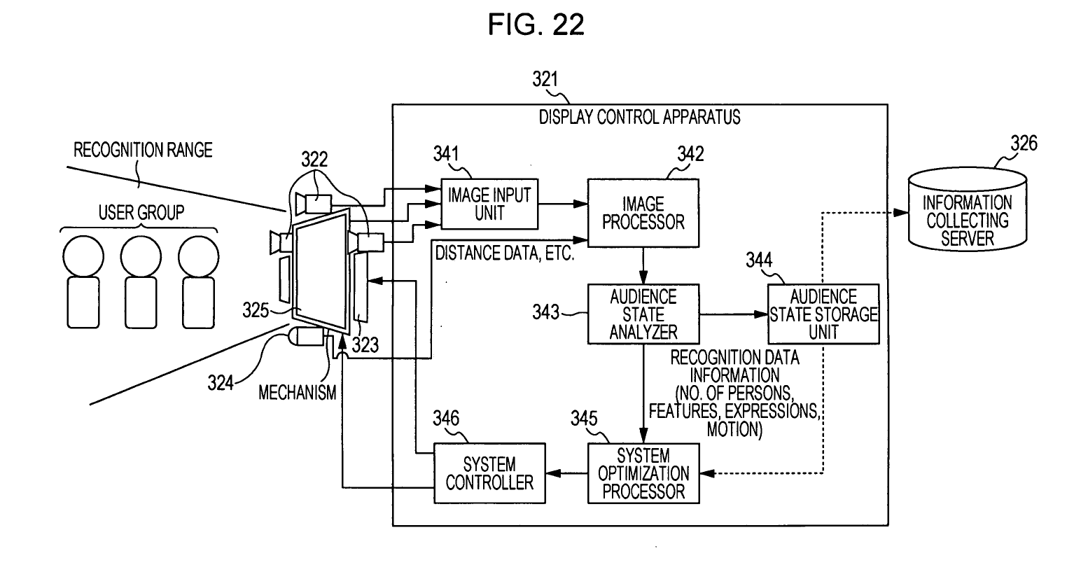

In so doing, the possibility that the subject has moved can be recognized more quickly. For example, consider the case wherein a state recognition apparatus (such as the display control apparatus 321 in FIG. 22, to be later described) is connected to the image processing apparatus 101. The state recognition apparatus recognizes the state of the subject on the basis of the analysis results from the state analyzer 124. In this case, the state recognition apparatus is able to use the moving body region information supplied from the state analyzer 124 prior to the analysis results to more quickly recognize the possibility that the subject has moved.

The controller 125 controls the components from the camera 21 to the camera position estimator 24, the components from the subject detector 26 to the detailed information acquirer 28, and the components from the moving body detector 121 to the state analyzer 124. From among the shot images acquired by the camera 21, the controller 125 causes a full scan to be conducted at a frequency of one frame per several frames, while also causing partial scans to be conducted with respect to the remaining frames.

### Operation of Second Subject Detection Process

The flowchart in FIG. 14 will now be used to describe in detail a second subject detection process conducted by the image processing apparatus 101.

In steps S31 and S32, processing similar to that of steps S1 and S2 in FIG. 8 is conducted.

In step S33, the controller 125 determines whether or not to conduct a full scan. This determination is made on the basis of the number of shot images that have been acquired by the imaging of the camera 21. If the controller 125 determines to not conduct a full scan on the basis of the number of shot images acquired by the imaging of the camera 21, then the process proceeds to step S41. In other words, the process proceeds to step S41 when the controller 125 determines to conduct a partial scan.

In steps S41 to S43, processing similar to that of steps S9 to S11 in FIG. 8 is conducted.

Meanwhile, if the controller 125 determines to conduct a full scan on the basis of the number of shot images acquired by the imaging of the camera 21, then the process proceeds to step S34.

In steps S34 and S35, processing similar to that of steps S4 and S5 in FIG. 8 is conducted.

In step S36, the moving body detector 121 detects a moving body in a shot image 41 from the camera 21 on the basis of face region information from the subject detector 26, a shot image 41 from the camera 21, and a background image from the background renewal unit 122, as shown in FIG. 11.

In step S37, the background renewal unit 122 uses the face region information from the subject detector 26 as well as moving body region information from the moving body detector 121 as a basis for determining which regions in the shot image 41 from the camera 21 correspond to the background region 161 for the background portion, and which regions correspond to the region 162 for all portions other than the background portion, as shown in FIG. 12.

Subsequently, the background renewal unit 122 conducts the background renewal process. In other words, the background renewal unit 122 acquires a renewed background image 182 from a background image 181 by performing weighted addition of the background region 161 and the non-background region 162 using respectively different ratios.

In step S38, the detection region determining unit 123 may, for example, determine the full scan detection region to be the moving body region 201 indicated by the moving body region information supplied from the moving body detector 121, as shown in FIG. 13.

As another example, the detection region determining unit 123 may also be configured to first determine a detection region on the basis of estimation results from the camera position estimator 24, and also determine a detection region on the basis of moving body region information from the moving body detector 121. The detection region determining unit 123 may then determine the final detection region to be the combined region portions from the regions determined above.

In steps S39, S40, and S44, processing is conducted similar to that of steps S7, S8, and S12 in FIG. 8, respectively.

In step S45, the state analyzer 124 analyzes the state of the subject on the basis of detailed information from the detailed information acquirer 28, and then outputs the analysis results. In addition, in cases where the processing to analyze the state of the subject involves a large amount of time, the state analyzer 124 also outputs the moving body region information from the moving body detector 121 prior to outputting the analysis results.

Once the processing in step S45 has finished, the process returns to step S31, and processing similar to the above is conducted thereafter.

As described above, according to the second subject detection process, the detection region determining unit 123 may determine the detection region to be a moving body region within a shot image 41 when conducting a full scan, for example.

Consequently, according to the second subject detection process, it becomes possible to detect subjects more quickly and with less computation compared to the case wherein entire image regions within the image pyramid 43 are set as detection regions for each frame.

### Example of Varying Moving Body Threshold Value in Frame Subtraction Process

Meanwhile, as described earlier, a frame subtraction process may be implemented instead of the background subtraction process as the method whereby the moving body detector 121 detects a moving body.

Due to the load on the controller 125 or other factors, the frame rate of shot images supplied from the camera 21 to the moving body detector 121 may change. In such cases, if a fixed moving body threshold value is used in the frame subtraction process without taking the frame rate change into account, a situation may occur wherein certain movements of the moving body are misdetected.

In other words, in cases where the frame rate increases due to a change in the frame rate (i.e., in cases where the imaging interval between adjacent frames becomes shorter), the movements of the moving body produced between adjacent frames become comparatively smaller. For this reason, if a fixed moving body threshold value is used, slight movements by the moving body might not be detected.

As another example, in cases where the frame rate decreases due to a change in the frame rate (i.e., in cases where the imaging interval between adjacent frames becomes longer), the movements of stationary bodies not being treated as moving bodies become comparatively larger. For this reason, if a fixed moving body threshold value is used, large movements by stationary bodies might be misdetected as movements by the moving body.

Thus, in cases where there is change in the frame rate of shot images supplied to the moving body detector 121 from the camera 21, it is preferable to suitably vary the moving body threshold value in accordance with the change in the frame rate.

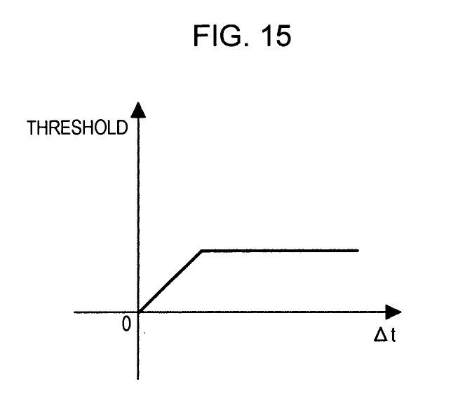

FIG. 15 illustrates one example of how the moving body threshold value may be varied according to the frame rate.

In FIG. 15, the horizontal axis represents the time Δt between adjacent frames, while the vertical axis represents the moving body threshold value.

In cases where the time Δt is short (i.e., in cases where the frame rate is high), the movements of the moving body displayed between adjacent frames become small. In contrast, in cases where the time Δt is long (i.e., in cases where the frame rate is low), the movements of the moving body displayed between adjacent frames become large.

Consequently, since the movements of the moving body between frames become smaller in cases where the time Δt is short, the moving body detector 121 decreases the moving body threshold value, as shown in FIG. 15. As the time Δt becomes longer, the movements of the moving body between frames become larger, and thus the moving body detector 121 increases the moving body threshold value.

In so doing, it becomes possible to detect certain movements by the moving body without misdetecting stationary bodies, even when the frame rate changes.

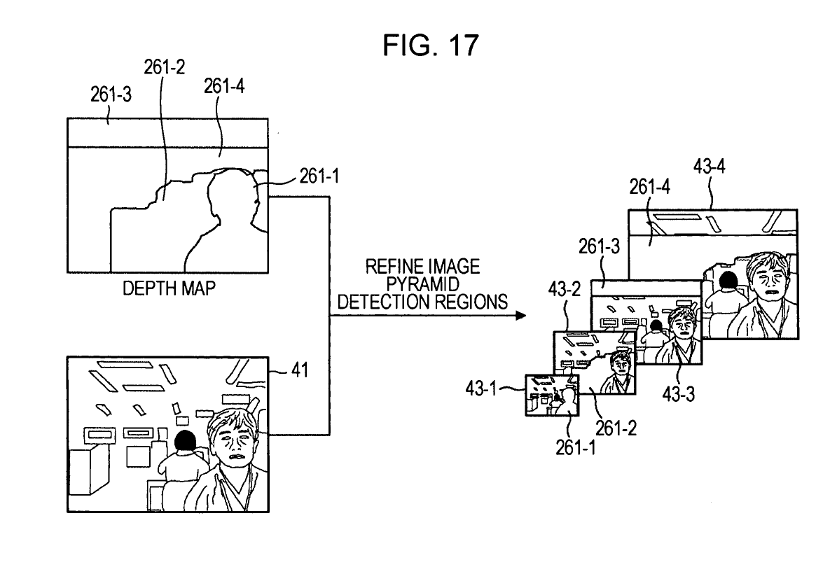

Herein, the second embodiment is configured such that the full scan detection regions are determined on the basis of at least one of the following: estimation results from the camera position estimator 24 (i.e., the orientation of the camera 21), or a moving body region within a shot image 41. However, it should be appreciated that it is possible to configure the second embodiment to determine detection regions in ways other than the above. For example, detection regions may be determined by consulting a depth map (see FIG. 17, to be hereinafter described) that expresses distances from the camera 21 to an imaging target (in addition to the subject to be detected, the depth map may also include information on objects not targeted for detection).

### 4. Third Embodiment

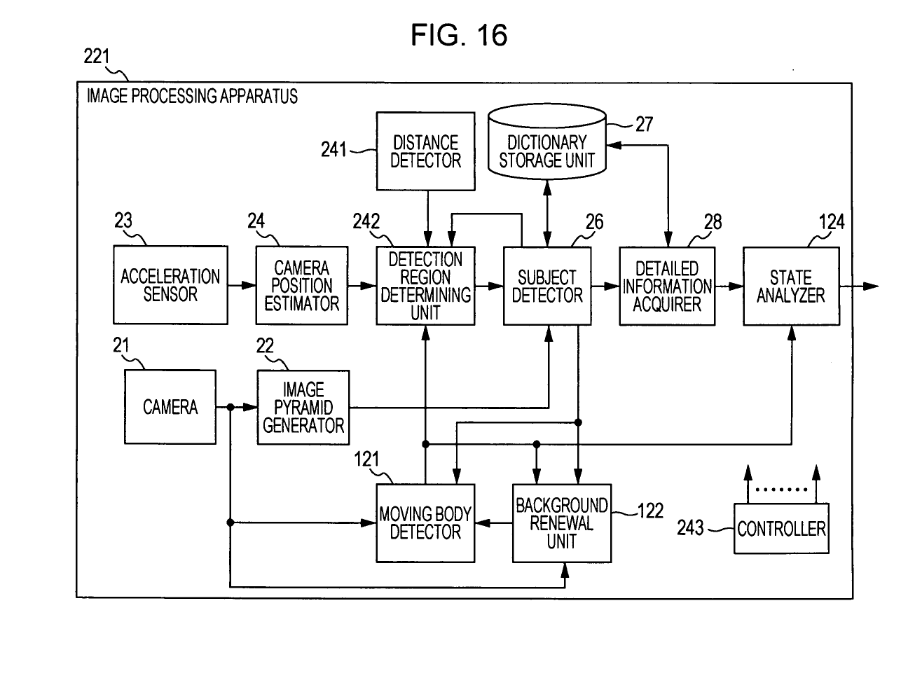

FIG. 16 illustrates an exemplary configuration of an image processing apparatus 221 in accordance with the third embodiment. The image processing apparatus 221 is configured to determine full scan detection regions by consulting a depth map that expresses distances from the camera 21 to an imaging target.

Herein, portions in FIG. 16 that correspond to the second embodiment illustrated in FIG. 10 are given identical reference numbers, and further description of such portions may be hereinafter omitted.

Thus, the image processing apparatus 221 in accordance with the third embodiment is newly provided with a distance detector 241. In addition, the detection region determining unit 123 and the controller 125 have been replaced by a detection region determining unit 242 and a controller 243, respectively. Otherwise, the third embodiment is configured similarly to the second embodiment.

The distance detector 241 includes a component such as a laser rangefinder, for example. By means of the laser rangefinder, the distance detector 241 shines a laser towards an imaging target, and detects the reflected light obtained as a result of the laser illuminating the imaging target and being reflected back. Subsequently, the distance detector 241 measures the amount of time between when the laser was shined towards the imaging target, and when the reflected light was detected. On the basis of the measured amount of time and the laser's speed, the distance from the distance detector 241 (i.e., the image processing apparatus 221) to the imaging target is computed.

The distance detector 241 then supplies the detection region determining unit 242 with distance information, which associates computed distances with positions in the imaging target.

It should be appreciated that the distance detector 241 may be configured to compute the distance to the imaging target in ways other than the above. For example, a stereo method involving a plurality of cameras may be used, wherein the parallax among the plurality of cameras is used to compute the distance to the imaging target.

On the basis of the distance information from the distance detector 241, the detection region determining unit 242 generates a depth map expressing the distance to an imaging target displayed in a shot image 41.

Subsequently, the detection region determining unit 242 determines respective detection regions for the pyramid images 43-1 to 43-4 on the basis of the generated depth map, for example. The method for determining detection regions on the basis of a depth map will be later described in detail with reference to FIG. 17.

Herein, the detection region determining unit 242 generates a depth map, and then determines detection regions on the basis of the generated depth map. Besides the above, however, it is possible for the detection region determining unit 242 to determine detection regions on the basis of at least one of the following: estimation results from the camera position estimator 24, moving body region information from the moving body detector 121, or the generated depth map.

As a more specific example, it is possible for the detection region determining unit 242 to first determine detection regions on the basis of estimation results from the camera position estimator 24, as well as detection regions on the basis of moving body region information from the moving body detector 121. The detection region determining unit 242 may then determine the final detection region to be the combined region portions from at least one of the above detection regions, as well as detection regions determined on the basis of a generated depth map.

### Exemplary Determination of Detection Regions on the Basis of Depth Map

FIG. 17 illustrates the details of a process whereby the detection region determining unit 242 determines full scan detection regions on the basis of a depth map generated using distance information from the distance detector 241.

As shown on the left side of FIG. 17, the detection region determining unit 242 generates a depth map on the basis of distance information from the distance detector 241.

There are several regions in the depth map illustrated on the left side of FIG. 17. The region 261-1 expresses the distance from the camera 21 to the portions of the imaging target existing within a spatial range D1 (i.e., the region 261-1 is the region where the portions of the imaging target existing within the spatial range D1 are displayed). The region 261-2 expresses the distance from the camera 21 to the portions of the imaging target existing within a spatial range D2 (i.e., the region 261-2 is the region where the portions of the imaging target existing within the spatial range D2 are displayed).

The region 261-3 expresses the distance from the camera 21 to the portions of the imaging target existing within a spatial range D3 (i.e., the region 261-3 is the region where the portions of the imaging target existing within the spatial range D3 are displayed). The region 261-4 expresses the distance from the camera 21 to the portions of the imaging target existing within a spatial range D4 (i.e., the region 261-4 is the region where the portions of the imaging target existing within the spatial range D4 are displayed).

As shown on the right side of FIG. 17, the detection region determining unit 242 determines the region 261-1 in the generated depth map to be the detection region for the pyramid image 43-1. This detection region will be used to detect the faces of one or more persons existing within the spatial range D1.

In addition, the detection region determining unit 242 determines the region 261-2 in the generated depth map to be the detection region for the pyramid image 43-2. This detection region will be used to detect the faces of one or more persons existing within the spatial range D2.

The detection region determining unit 242 determines the region 261-3 in the generated depth map to be the detection region for the pyramid image 43-3. This detection region will be used to detect the faces of one or more persons existing within the spatial range D3.

The detection region determining unit 242 determines the region 261-4 in the generated depth map to be the detection region for the pyramid image 43-4. This detection region will be used to detect the faces of one or more persons existing within the spatial range D4.

The detection region determining unit 242 then supplies the subject detector 26 with detection region information, which expresses the determined detection regions.

The controller 243 controls the components from the camera 21 to the camera position estimator 24, the components from the subject detector 26 to the detailed information acquirer 28, as well as the moving body detector 121, the background renewal unit 122, the state analyzer 124, the distance detector 241, and the detection region determining unit 242. From among the shot images acquired by the camera 21, the controller 243 causes a full scan to be conducted at a frequency of one frame per several frames, while also causing partial scans to be conducted with respect to the remaining frames.

### Operation of Third Subject Detection Process

A third subject detection process conducted by the image processing apparatus 221 will now be described with reference to the flowchart in FIG. 18.

In steps S61 and S62, processing similar to that of steps S31 and S32 in FIG. 14 is conducted.

In step S63, the controller 243 determines whether or not to conduct a full scan. This determination is made on the basis of the number of shot images that have been acquired by the imaging of the camera 21. If the controller 243 determines to not conduct a full scan on the basis of the number of shot images acquired by the imaging of the camera 21, then the process proceeds to step S72. In other words, the process proceeds to step S72 when the controller 243 determines to conduct a partial scan.

In steps S72 to S74, processing similar to that of steps S41 to S43 in FIG. 14 is conducted.

Meanwhile, if in step S63 the controller 243 determines to conduct a full scan on the basis of the number of shot images that have been acquired by the imaging of the camera 21, then the process proceeds to step S64.

In steps S64 to S67, processing similar to that of steps S34 to S37 in FIG. 14 is conducted.

In step S68, the distance detector 241 shines a laser towards the imaging target, and detects the reflected light obtained as a result of the laser illuminating the imaging target and being reflected back. Subsequently, the distance detector 241 measures the amount of time between when the laser was shined towards the imaging target, and when the reflected light was detected. On the basis of the measured amount of time and the laser's speed, the distance from the distance detector 241 (i.e., the image processing apparatus 221) to the imaging target is computed.

The distance detector 241 then supplies the detection region determining unit 242 with distance information, which associates computed distances with positions in the imaging target.

In step S69, the detection region determining unit 242 generates a depth map on the basis of the distance information from the distance detector 241. The depth map expresses the distances to one or more subjects displayed in a shot image 41.

Subsequently, the detection region determining unit 242 uses the generated depth map as a basis for determining respective detection regions for the pyramid images 43-1 to 43-4. The detection region determining unit 242 then supplies the subject detector 26 with detection region information, which expresses the determined detection regions.

As described earlier, it should be appreciated that, in addition to the depth map, it is also possible for the detection region determining unit 242 to determine detection regions on the basis of information such as moving body region information from the moving body detector 121 and estimation results from the camera position estimator 24.

In steps S70, S71, S75, and S76, processing is conducted similar to that of steps S39, S40, S44, and S45 in FIG. 14, respectively.

As described above, according to the third subject detection process, the detection region determining unit 242 may determine the detection region to be a particular region from among the regions in the image pyramid 43 when conducting a full scan. This determination is made on the basis of a depth map, which expresses the distance to the imaging target.

Consequently, according to the third subject detection process, it becomes possible to detect subjects more quickly and with less computation compared to the case wherein entire image regions within the image pyramid 43 are set as detection regions for each frame.

### 5. Modifications

The first through the third embodiments are configured such that, when conducting a full scan, the subject detector 26 detects faces existing in the respective detection regions for all of the pyramid images 43-1 to 43-4.

However, in the first through the third embodiments, subjects that are closer to the image processing apparatus 1 (or 101 or 221) are more important subjects for detection. By taking this factor into account, an embodiment may also be configured to detect one or more human faces from individual pyramid images in the order 43-1, 43-2, 43-3, 43-4 (i.e., one or more human faces may be detected from individual spatial ranges in the order D1, D2, D3, D4). The process may then be terminated once the number of detected faces meets or exceeds a predetermined number.

In this case, it becomes possible to shorten processing time, while still enabling detection of human faces that are important for detection.

In addition, in the first through the third embodiments, the subject detector 26 is configured to detect one or more faces in the entirety of the one or more regions set as the detection region. However, if there exist regions where one or more faces have already been detected, then those regions may be removed from the detection region, and the final detection region may be determined to be the region that remains after such removal.

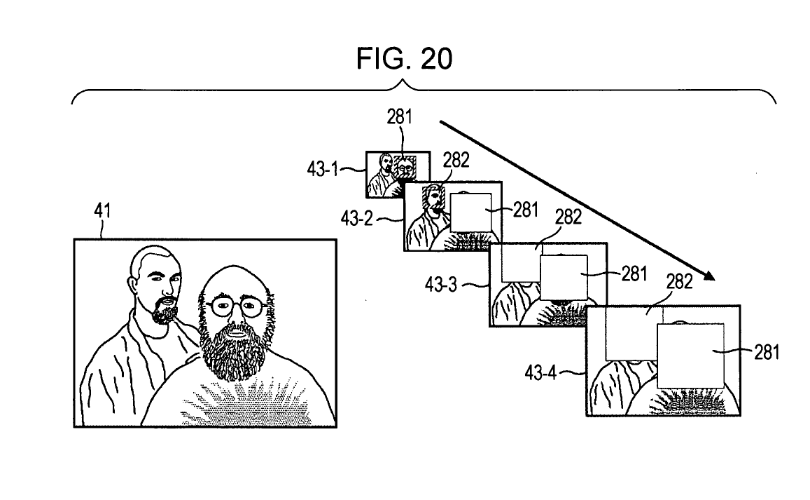

As an example, consider the case illustrated in FIG. 20, wherein a face region 281 has been detected in the detection region for the pyramid image 43-1 (in this case, the detection region is the entire pyramid image 43-1). In this case, the face region 281 is removed from the detection region for the pyramid image 43-2 (in this case, the detection region before removal is the entire pyramid image 43-2).

It is possible to configure an embodiment such that, if another face region 282 is subsequently detected in the pyramid image 43-2, then both the face region 281 and the face region 282 are removed from the detection region for the pyramid image 43-3 (in this case, the detection region before removal is the entire pyramid image 43-3). The face region 281 and the face region 282 are likewise removed from the detection region for the pyramid image 43-4 (in this case, the detection region before removal is the entire pyramid image 43-4).

In addition, in the first through the third embodiments, the subject detector 26 is configured such that, for each shot image, the subject detector 26 successively focuses on each of the plurality of pixels constituting a detection region within the image pyramid 43 corresponding to the current shot image. The subject detector 26 then extracts a comparison region by taking a square region containing four pixels total, with the current focus pixel set as the upper-left pixel. The subject detector 26 then compares the extracted comparison region to a template, and conducts face detection on the basis of the comparison results.

However, the subject detector 26 may also focus on only ¼ the pixels with respect to the image pyramid 43, for example, and thereby reduce the number of extracted comparison regions to ¼. In so doing, it becomes possible to shorten the processing time involved in face detection.

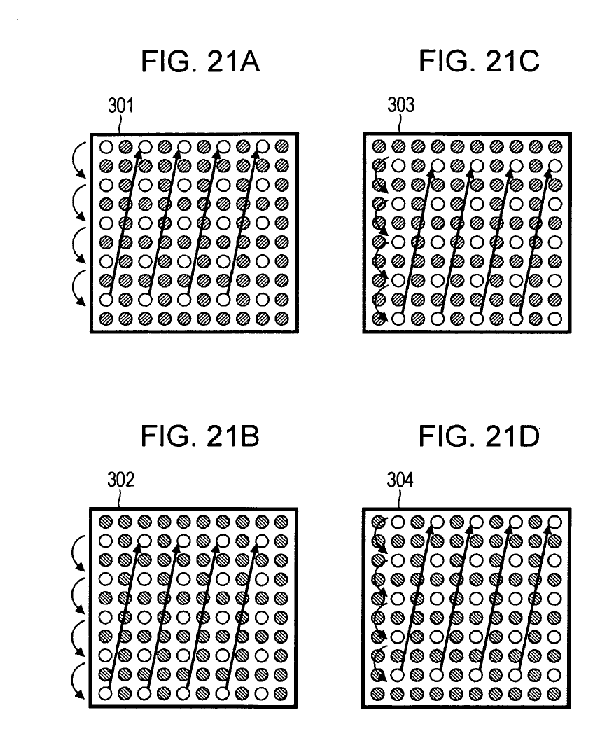

FIGS. 21A to 21D will now be used to describe one example of a method for extracting square comparison regions from the image pyramid 43 for comparison with a template.

The detection region 301 shown in FIG. 21A illustrates the detection region for a first full scan conducted at a given time. The detection region 302 shown in FIG. 21B illustrates the detection region for a second full scan conducted next after the first full scan.

The detection region 303 shown in FIG. 21C illustrates the detection region for a third full scan conducted next after the second full scan. The detection region 304 shown in FIG. 21D illustrates the detection region for a fourth full scan conducted next after the third full scan.

As an example, during the first full scan, the subject detector 26 may successively set the focus pixel to be the one of the pixels shown in white from among the plurality of pixels constituting the detection region 301 (see FIG. 21A) in the image pyramid 43.

The subject detector 26 also extracts square comparison regions containing four pixels total, with each successive focus pixel respectively set as the upper-left pixel. The subject detector 26 compares the extracted comparison regions to a template, and conducts face detection on the basis of the comparison results.

As another example, during the second full scan, the subject detector 26 may successively set the focus pixel to be the one of the pixels shown in white from among the plurality of pixels constituting the detection region 302 (see FIG. 21B) in the image pyramid 43.

The subject detector 26 also extracts square comparison regions containing four pixels total, with each successive focus pixel respectively set as the upper-left pixel. The subject detector 26 compares the extracted comparison regions to a template, and conducts face detection on the basis of the comparison results.

As another example, during the third full scan, the subject detector 26 may successively set the focus pixel to be the one of the pixels shown in white from among the plurality of pixels constituting the detection region 303 (see FIG. 21C) in the image pyramid 43.

The subject detector 26 also extracts square comparison regions containing four pixels total, with each successive focus pixel respectively set as the upper-left pixel. The subject detector 26 compares the extracted comparison regions to a template, and conducts face detection on the basis of the comparison results.

As another example, during the fourth full scan, the subject detector 26 may successively set the focus pixel to be the one of the pixels shown in white from among the plurality of pixels constituting the detection region 304 (see FIG. 21D) in the image pyramid 43.

The subject detector 26 also extracts square comparison regions containing four pixels total, with each successive focus pixel respectively set as the upper-left pixel. The subject detector 26 compares the extracted comparison regions to a template, and conducts face detection on the basis of the comparison results.

In so doing, the number of pixels set as focus pixels can be set to ¼ compared to the case when all pixels constituting the detection region are set as focus pixels. For this reason, the number of extracted comparison regions also becomes ¼, thereby making it possible to shorten the processing time.

In addition, according to the comparison region extraction method illustrated in FIG. 21, although the number of comparison regions respectively extracted from the detection regions 301 to 304 becomes ¼, the size of the detection region itself does not reduce to ¼, but instead remains the same. For this reason, it becomes possible to prevent the face detection rate from falling to ¼ as a result of decreasing the number of comparison regions to ¼.

It should be appreciated that the comparison region extraction method illustrated in FIG. 21 can also be applied to partial scan detection regions.

In addition, the method for determining detection regions is not limited to the detection region determination methods described in the first through the third embodiments. Any one of the plurality of determination methods described in the foregoing may be used to determine detection regions. Alternatively, at least two or more of the plurality of determination methods may be used to respectively determine detection regions. The final detection region may then be determined to be the combined region portions from the regions determined above.

In the first embodiment, the image processing apparatus 1 is described as housing both the camera 21 and the acceleration sensor 23. Besides this configuration, however, the camera 21 and the acceleration sensor 23 may be configured separately from the image processing apparatus 1, and not housed therein. Similar reasoning may also be applied to the second and third embodiments.

In the third embodiment, the image processing apparatus 221 is described as housing the distance detector 241. Besides this configuration, however, the distance detector 241 may be configured separately from the image processing apparatus 221, and not housed therein.

Although the first subject detection process is configured such that a partial scan is not conducted when conducting a full scan, the first subject detection process is not limited thereto. In other words, the first subject detection process may also be configured such that a partial scan is also conducted when conducting a full scan, for example.

In this case, more partial scans will be conducted in the first subject detection process. As a result, the detailed information acquirer 28 will be able to acquire a greater quantity of detailed information, while the state analyzer 29 will be able to analyze the state of the subject in more detail on the basis of the acquired detailed information. Similar reasoning may also be applied to the second and third subject detection processes.

### 6. Fourth Embodiment

FIG. 22 illustrates an exemplary configuration of a display control apparatus 321. The display control apparatus 321 includes an image processor 342 that conducts processing similar to that of the image processing apparatus 1, 101, or 221.

The display control apparatus 321 is connected to the following: a camera group 322 made up of a plurality of cameras; one or more speakers 323 that output audio; a sensor group 324 made up of a plurality of sensors, such as an acceleration sensor, an angular velocity sensor, a laser range finder; a display 325 that displays television programs or other content; and an information collecting server 326 that stores information collected by the display control apparatus 321.

The display control apparatus 321 is provided with an image input unit 341, an image processor 342, an audience state analyzer 343, an audience state storage unit 344, a system optimization processor 345, and a system controller 346.

The image input unit 341 supplies (i.e., inputs) shot images from the camera group 322 to the image processor 342.

The image processor 342 is supplied with shot images from the image input unit 341, while also being supplied with various information from the sensor group 324. For example, the image processor 342 may receive accelerations detected by an acceleration sensor, angular velocities detected by an angular velocity sensor, and the distance to the imaging target detected by a laser range finder.

On the basis of the accelerations, angular velocities, or distance to the imaging target supplied from the sensor group 324, as well as the shot images supplied from the image input unit 341, the image processor 342 conducts processing similar to that of the first through the third subject detection processes described earlier. The image processor 342 then supplies the audience state analyzer 343 with the resulting analysis results regarding the state of one or more subjects.

On the basis of the analysis results from the image processor 342, the audience state analyzer 343 analyzes the attentiveness of one or more users (i.e., subjects) viewing the images (i.e., television programs) displayed on the display 325. The audience state analyzer 343 then supplies the analysis results to the audience state storage unit 344 and the system optimization processor 345 as recognition data information.

Via a network such as the Internet or a local area network (LAN), the audience state storage unit 344 sends and stores (i.e., records) the recognition data information supplied from the audience state analyzer 343 in the information collecting server 326. In addition, the audience state storage unit 344 receives recognition data information supplied from the information collecting server 326 via a network such as the Internet or a LAN, and supplies the received information to the system optimization processor 345.

On the basis of recognition data information supplied from either the audience state analyzer 343 or the audience state storage unit 344, the system optimization processor 345 causes the system controller 346 to conduct optimal control with respect to the attentiveness of the one or more users.

Following the instructions of the system optimization processor 345, the system controller 346 adjusts various settings, such as: the display brightness of the display 325; the program content displayed on the display 325; and the volume of the audio output from the one or more speakers 323.

Meanwhile, in the display control apparatus 321, the audience state analyzer 343 is configured to analyze the attentiveness of one or more users on the basis of analysis results regarding the state of one or more subjects supplied from the image processor 342.

Consequently, in cases where the subject state analysis process for analyzing the state of one or more subjects in the image processor 342 involves a large amount of time, the audience state analyzer 343 would be unable to analyze the user attentiveness until the subject state analysis process has finished.

In such cases, the audience state analyzer 343 might not be able to quickly analyze the user attentiveness as a result of the lengthy time involved in the subject state analysis process.

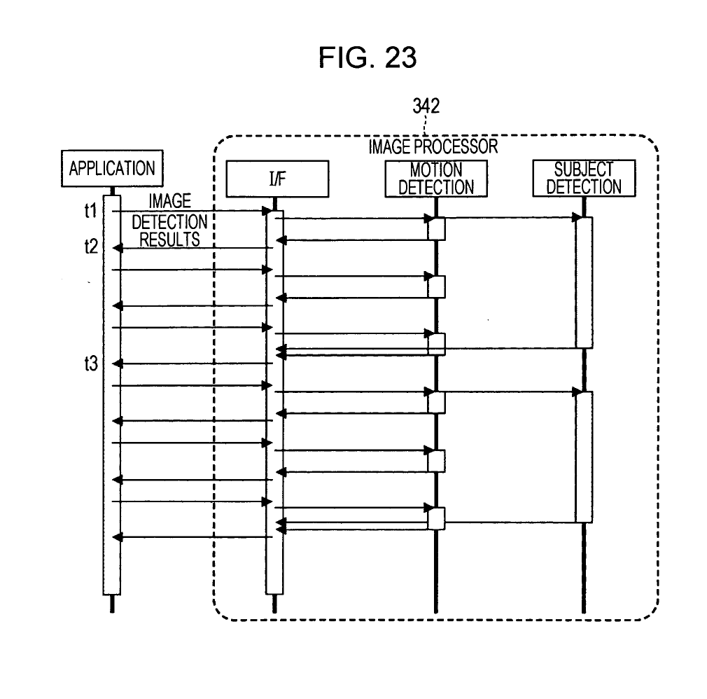

Thus, the image processor 342 may be configured such that, in cases where the subject state analysis process involves a large amount of time, moving body region information is supplied to the audience state analyzer 343 prior to the analysis results obtained as a result of the subject state analysis process, as shown in FIG. 23.

### Exemplary Image Processor 342

FIG. 23 illustrates one example of an image processor 342 that outputs moving body region information prior to the analysis results obtained as a result of the subject state analysis process.

The image processor 342 is configured similarly to the image processing apparatus 101 or 221 in the second or third embodiment.

In FIG. 23, “APPLICATION” refers to the applications corresponding to the image input unit 341 and the audience state analyzer 343 in the display control apparatus 321.

As shown by way of example in FIG. 23, at a time t1, the image processor 342 may detect a moving body region in a shot image supplied from the image input unit 341 application, and determine the full scan detection region to be the detected moving body region. Subsequently, the image processor 342 may detect one or more subjects in the determined detection region, and analyze the state of one or more subjects on the basis of the detection results. At the time t3, the image processor 342 is outputting the analysis results to the audience state analyzer 343 application.

In this case, the audience state analyzer 343 is unable to analyze the user attentiveness until the analysis results are output from the image processor 342 at time t3.

Consequently, the image processor 342 is configured such that, after having detected the moving body region in the shot image supplied from the image input unit 341 application at time t1, the image processor 342 outputs moving body region information expressing the detected moving body region to the audience state analyzer 343 application at a time t2, wherein time t2 is earlier than time t3.

In so doing, it becomes possible for the audience state analyzer 343 application to use the moving body region information supplied from the image processor 342 as a basis for determining the possibility of user movement. By utilizing such information as the state of user attentiveness, the audience state analyzer 343 is able to analyze the subject state sooner.

If the image processor 342 includes functions similar to the image processing apparatus 1 in accordance with the first embodiment, then a moving body detector 121 may also be provided as in the second and third embodiments.

Furthermore, the processing to detect moving body regions that is executed in a moving body detector 121 provided in the image processor 342 may be accelerated by means of parallel processing, for example. In so doing, the moving body region information can be output prior to the analysis results that are output by the subject state analysis process conducted in the components from the camera 21 to the state analyzer 29 (see FIG. 2).

The foregoing series of processes can be executed in dedicated hardware, or in software. In the case where the series of process is executed in software, a program constituting such software may be installed from a recording medium onto what is referred to as a built-in or embedded computer. Alternatively, such a program may be installed from a recording medium onto a general-purpose personal computer or similar apparatus that is able to execute a variety of functions as a result of installing various programs thereon.

### Exemplary Configuration of Computer

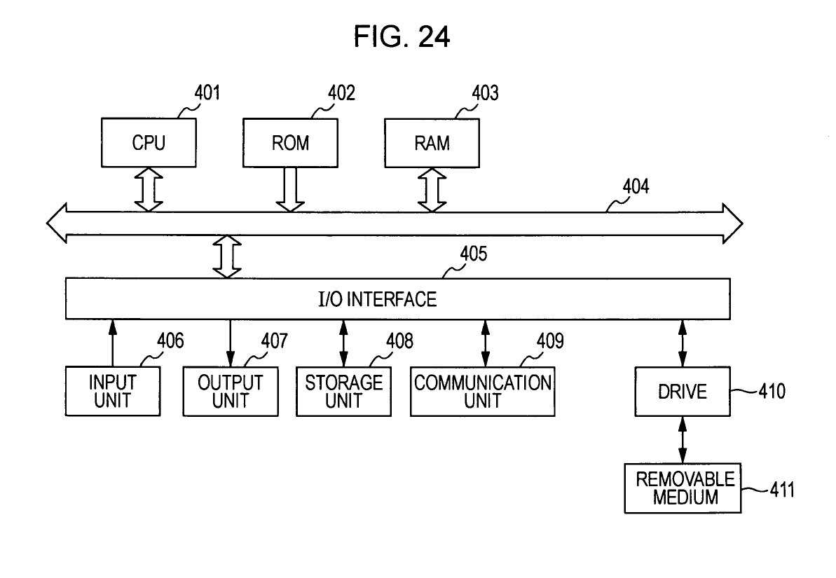

FIG. 24 illustrates an exemplary configuration of a computer that executes the foregoing series of processes by means of a program.

The central processing unit (CPU) 401 executes various processes by following a program stored in read-only memory (ROM) 402 or a storage unit 408. Programs executed by the CPU 401 and other data is stored as appropriate in random access memory (RAM) 403. The CPU 401, the ROM 402, and the RAM 403 are connected to each other by a bus 404.

The CPU 401 is also connected to an input/output (I/O) interface 405 by the bus 404. The following is connected to the I/O interface 405: an input unit 406, which may include devices such as a keyboard, mouse, and microphone; and an output unit 407, which may include devices such as a display and one or more speakers. The CPU 401 executes various processes in accordance with commands input from the input unit 406. The CPU 401 then outputs the process results to the output unit 407.

The storage unit 408 connected to the I/O interface 405 may include a hard disk, for example. The storage unit 408 stores information such as programs executed by the CPU 401 and various data. A communication unit 409 communicates with external apparatus via a network such as the Internet or a local area network.

In addition, programs may be acquired via the communication unit 409 and stored in the storage unit 408.

A drive 410 is connected to the I/O interface 405. A removable medium 411 such as an magnetic disk, an optical disc, a magneto-optical disc, or semiconductor memory may be loaded into the drive 410. The drive 410 drives the removable medium 411, and acquires programs, data, or other information recorded thereon. Acquired programs and data may be transferred to the storage unit 408 and stored as appropriate.

The recording medium storing the program that is installed onto a computer and rendered into an executable state by the computer may be packaged media provided as a removable medium 411 in the form of one or more magnetic disks (including flexible disks), optical discs (including Compact Disc Read-Only Memory (CD-ROM) discs and Digital Versatile Discs (DVDs)), magneto-optical discs (including Mini-Discs (MDs)), or semiconductor memory, as illustrated in FIG. 24. Alternatively, such a recording medium may be realized by the ROM 402 temporarily or permanently storing such a program, or by a device such as a hard disk constituting the storage unit 408. The recording of the program onto the recording medium may be conducted by utilizing a wired or wireless communication medium such as a local area network, the Internet, or digital satellite broadcast, and any communication on such a communication medium may be conducted via one or more routers, modems, or interfaces constituting the communication unit 409, as appropriate.

The steps stating the program recorded onto the recording medium may obviously include processes conducted in a time series following the order given in the present specification. However, it should also be appreciated that such steps may also include processes that are executed in parallel or individually, without being processed in a strict time series.

It should also be appreciated that embodiments of the present invention are not limited to the first through the fourth embodiments described in the foregoing, and that various modifications are possible without departing from the scope and spirit of the present invention.

The present application contains subject matter related to that disclosed in Japanese Priority Patent Application JP 2009-202266 filed in the Japan Patent Office on Sep. 2, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus configured to detect one or more subjects set as detection targets from a shot image acquired by imaging, the image processing apparatus comprising:
generating means for generating an image pyramid used to detect the one or more subjects, wherein the image pyramid is generated by reducing or enlarging the shot image using scales set in advance according to the distance from the imaging unit that conducts the imaging to the one or more subjects to be detected;
determining means for determining, from among the entire image regions in the image pyramid, one or more detection regions for detecting the one or more subjects; and
subject detecting means for detecting the one or more subjects from the one or more detection regions.

2. The image processing apparatus according to claim 1, further comprising:
estimating means for estimating the orientation of the imaging unit;
wherein
the determining means determines the one or more detection regions on the basis of the estimated orientation of the imaging unit.

3. The image processing apparatus according to claim 2, further comprising:
acquiring means for acquiring detailed information regarding the one or more subjects, on the basis of the subject detection results;
wherein
in the case where it is estimated that the orientation of the imaging unit is fixed in a particular direction, the determining means determines the one or more detection regions on the basis of the acquired detailed information.

4. The image processing apparatus according to claim 3, wherein
the detailed information acquired by the acquiring means at least includes position information expressing the positions of the one or more subjects in the shot image, and
on the basis of the position information, the determining means determines the one or more detection regions to be the regions in the shot image where the probability of a subject existing therein is equal to or greater than a predetermined threshold value.

5. The image processing apparatus according to claim 1, further comprising:
moving body detecting means for detecting a moving body region representing a moving body in the shot image;
wherein
the determining means determines the one or more detection regions to be the detected moving body region.

6. The image processing apparatus according to claim 5, wherein
the moving body detecting means sets moving body threshold values used to detect the moving body region from among the regions constituting the shot image, and
different moving body threshold values are set for subject vicinity regions that contain the one or more subjects detected by the subject detecting means, and for all regions other than the subject vicinity regions.

7. The image processing apparatus according to claim 5, wherein
in the case where the moving body detecting means detects the moving body region on the basis of whether or not the absolute difference between shot images in adjacent frames is equal to or greater than a moving body threshold value used to detect the moving body region,
the moving body detecting means modifies the moving body threshold value according to the difference in imaging times between the shot images.

8. The image processing apparatus according to claim 5, further comprising:
background renewing means for conducting a background renewal process with respect to the regions constituting the shot image;
wherein
in the case where the moving body detecting means detects the moving body region on the basis of the absolute difference between the shot image, and a background image of only the background wherein the one or more subjects are not captured,
the background renewal process differs for the regions corresponding to the background portions in the shot image, and for the regions corresponding to all portions other than the background in the shot image.

9. The image processing apparatus according to claim 5, further comprising:
outputting means for outputting moving body region information that expresses the moving body region detected by the moving body detecting means, wherein the outputting means outputs the moving body region information before the one or more subjects are detected by the subject detecting means.

10. The image processing apparatus according to claim 1, further comprising:
distance computing means for computing the distances to imaging targets imaged by the imaging unit; and
map generating means for generating a depth map on the basis of the computed distances, wherein the depth map express the distances to respective imaging targets in the shot image;
wherein
the determining means determines the one or more detection regions on the basis of the depth map.

11. The image processing apparatus according to claim 1, wherein
the determining means subdivides the image pyramid into a plurality of regions according to the scales, and determines the one or more detection regions to be one from among the plurality of regions.

12. The image processing apparatus according to claim 1, wherein
the subject detecting means detects the one or more subjects in partial regions from among the one or more detection regions, and
the detection is made on the basis of whether or not a subject exists in respective partial regions that differ in position by n pixels (where n>1).

13. The image processing apparatus according to claim 1, wherein
the generating means generates an image pyramid containing a plurality of pyramid images by reducing or enlarging the shot image at respectively different scales, and
the subject detecting means detects the one or more subjects from the one or more detection regions for respective pyramid images in the image pyramid, wherein the one or more subjects are detected in order starting from the subject closest to the imaging unit.

14. The image processing apparatus according to claim 13, wherein
the subject detecting means terminates detection of the one or more subjects in the case where a predetermined number of subjects has been detected.

15. The image processing apparatus according to claim 13, wherein
the subject detecting means detects the one or more subjects from the one or more detection regions, wherein regions containing already-detected subjects have been removed from the one or more detection regions.

16. The image processing apparatus according to claim 1, wherein
in the case of detecting a subject existing in the shot image that has not yet been detected by the subject detecting means,
the subject detecting means detects the subject from the one or more detection regions on the basis of a first template image that expresses the subject as viewed from a particular direction.

17. The image processing apparatus according to claim 16, wherein
when given a subject that exists in a first shot image and has already been detected by the subject detecting means, in the case where that subject is to be detected in another shot image different from the first shot image,
on the basis of the position in the first shot image where the already-detected subject exists, the determining means additionally determines one or more detection regions in another image pyramid used to detect the subject in the other shot image, and
the subject detecting means detects the subject from the one or more detection regions in the other image pyramid on the basis of a plurality of second template images respectively expressing the subject as viewed from a plurality of directions.

18. An image processing method executed in an image processing apparatus configured to detect one or more subjects set as detection targets from a shot image acquired by imaging, the image processing apparatus including
generating means,
determining means, and
subject detecting means,
and the method comprising the steps of:
causing the generating means to generate an image pyramid used to detect the one or more subjects, wherein the image pyramid is generated by reducing or enlarging the shot image using scales set in advance according to the distance from the imaging unit that conducts the imaging to the one or more subjects to be detected;
causing the determining means to determine, from among the entire image regions in the image pyramid, one or more detection regions for detecting the one or more subjects; and
causing the subject detecting means to detect the one or more subjects from the one or more detection regions.

19. A program executed by the computer of an image processing apparatus configured to detect one or more subjects set as detection targets from a shot image acquired by imaging, the program causing the computer to function as:
generating means for generating an image pyramid used to detect the one or more subjects, wherein the image pyramid is generated by reducing or enlarging the shot image using scales set in advance according to the distance from the imaging unit that conducts the imaging to the one or more subjects to be detected;
determining means for determining, from among the entire image regions in the image pyramid, one or more detection regions for detecting the one or more subjects; and
subject detecting means for detecting the one or more subjects from the one or more detection regions.

20. An electronic device configured to detect one or more subjects set as detection targets from a shot image acquired by imaging, and conduct processing based on the detection results, the electronic device comprising:
generating means for generating an image pyramid used to detect the one or more subjects, wherein the image pyramid is generated by reducing or enlarging the shot image using scales set in advance according to the distance from the imaging unit that conducts the imaging to the one or more subjects to be detected;
determining means for determining, from among the entire image regions in the image pyramid, one or more detection regions for detecting the one or more subjects; and
subject detecting means for detecting the one or more subjects from the one or more detection regions.

21. An image processing apparatus configured to detect one or more subjects set as detection targets from a shot image acquired by imaging, the image processing apparatus comprising:
an image pyramid generator configured to generate an image pyramid used to detect the one or more subjects, wherein the image pyramid is generated by reducing or enlarging the shot image using scales set in advance according to the distance from the imaging unit that conducts the imaging to the one or more subjects to be detected;
a detection region determining unit configured to determine, from among the entire image regions in the image pyramid, one or more detection regions for detecting the one or more subjects; and
a subject detector configured to detect the one or more subjects from the one or more detection regions.

22. An electronic device configured to detect one or more subjects set as detection targets from a shot image acquired by imaging, and conduct processing based on the detection results, the electronic device comprising:
an image pyramid generator configured to generate an image pyramid used to detect the one or more subjects, wherein the image pyramid is generated by reducing or enlarging the shot image using scales set in advance according to the distance from the imaging unit that conducts the imaging to the one or more subjects to be detected;
a detection region determining unit configured to determine, from among the entire image regions in the image pyramid, one or more detection regions for detecting the one or more subjects; and
a subject detector configured to detect the one or more subjects from the one or more detection regions.
